(19) United States
(12) Patent Application Publication
(10) Pub. No.: US 2003/0044762 A1
(43) Pub. Date: Mar. 6, 2003

(54) Educational management system

(75) Inventors: John Richard Bergan, Tucson, AZ (US); John Robert Bergan, Tucson, AZ (US); Michael Rattee, Tucson, AZ (US); Brian Benson, Tucson, AZ (US)

Correspondence Address: Donald W. Marks, 3137 Mount Vernon Avenue, Alexandria, VA, 22305-2665, US

(73) Assignee: Assessment Technology Inc., Tucson, AZ

(21) Appl. No.: 10/228,962

(22) Filed: Aug. 28, 2002

Related U.S. Application Data
(60) Provisional application No. 60/315,258, filed on Aug. 29, 2001.

(51) Int. Cl. G09B 3/00

(52) U.S. Cl. 434/350; 434/118; 434/362

(57) ABSTRACT

A computerized education management system for users classified into hierarchical levels of administrative, super agency, agency, center and class levels employs a plurality of files classified into a plurality of different types of files with rights of access to the different types of the files for the different hierarchical levels. The different rights including read only access, copy access and full access with rights to modify and create records. Copy access enables a user to copy files to a level permitting the user with full access rights. The different file types including a teacher assignment file type, a student class assignment file type, a lesson plan file type and a student achievement file type. A form builder, a test builder and learning plan or activity map display procedures are provided

### CROSS-REFERENCE TO RELATED APPLICATIONS

This application adds new features to U.S. patent application No. 60/091,288 filed Jun. 30, 1998, now U.S. Pat. No. 6,322,366 and which is hereby incorporated herein in its entirety by reference. Further this application claims priority rights under U.S. provisional application No. 60/315,258 which is also incorporated herein by reference.

### BACKGROUND OF THE INVENTION

The present invention relates to a computer system for managing instruction and learning.

The prior art contains a number of computer systems for managing and assisting in the education of students. A typical system includes a network wherein administrators can monitor student progress, course curriculum and teacher performance. Teachers can individualize instruction for students based upon their recorded progress. Listed instructional materials can be categorized by grade level or objective to assist in lesson planning. Generally these prior art systems are designed to administer tests and homework to students and record the scores. Such systems generally have one or more deficiencies such as being unsuitable for managing education of younger students of preschool age and the first few years of school.

### BRIEF SUMMARY OF THE INVENTION

The additions presented here add to the development of the educational management system to assist stakeholders in the educational process to rapidly generate, archive, retrieve, deploy, and evaluate educational goals, assessment tools, instructional materials, lesson plans, reports, and other educational information in ways that can facilitate decisions, plans, and actions to promote learning. The system, with the included additions, is designed to operate within the context of the Internet and/or, on a smaller scale, a localized Intranet. In one aspect, the invention can be summarized in a computerized education management system which classifies files, such as teacher assignment files, student class assignment files, lesson plan files and student achievement files, into a plurality of different types of file such as teacher assignment file type, a student class assignment file type, a lesson plan file type and a student achievement file type and grants different rights of access to the different types of files based upon hierarchical level of a plurality of hierarchical levels in which users are classified. Different rights of access to the different types of the files include read only access, copy access and full access with rights to modify and create records.

One of the goals of the system is to facilitate the formation and implementation of a learning community comprised of various stakeholders whose aim is to promote learning. The community component is the vehicle through which the stakeholders gain access to services and content libraries in the system that can be used to facilitate learning. The community component includes security measures, which restrict service and library access. In addition, it includes various levels of permission, which enable users to utilize services and libraries to create, store, view, deploy, and evaluate content in the system. The instructional management system is unique in that it provides for interaction of all major stakeholders in the educational process, from policy makers to parents.

Various objects, advantages and features of the invention will be apparent from the following detailed description and accompanying drawings.

### BRIEF DESCRIPTION OF THE DRAWINGS

FIG. 1 is a diagram of one possible network of computers employed in an educational management system in accordance with one embodiment of the invention can be employed.

FIG. 2 is illustration of a library or file stored on a computer of FIG. 1.

FIG. 3 is table illustrating access rights to various file types in the education management system of FIG. 1.

FIG. 4 is a step diagram of an entry procedure employed in the education management system of FIG. 1.

FIG. 5 is an illustration of a computer screen used in the displayed in the step diagram of FIG. 4.

FIG. 6 is a step diagram of an administrative services procedure called from the procedure of FIG. 5

FIG. 7 is a step diagram of an add new form type service category procedure called from the procedure of FIG. 6.

FIG. 8 is a step diagram of an edit form type procedure called from the procedure of FIG. 7.

FIG. 9 is a step diagram of an add subcategory procedure called from the procedure of FIG. 8.

FIG. 10 is a step diagram of an edit subcategory procedure called from the procedure of FIG. 9

FIG. 11 is a step diagram of an add subcategory item procedure called from the procedure of FIG. 10.

FIG. 12 is a step diagram of an edit subcategory item procedure called from the procedure of FIG. 11.

FIG. 13 is a step diagram of a teaching services procedure called from the procedure of FIG. 4.

FIG. 14 is a step diagram of a K-12 procedure called from the procedure of FIG. 13.

FIG. 15 is a step diagram of a lesson plan procedure called from the procedure of FIG. 13.

FIG. 16 is a step diagram of activity procedure called from the procedure of FIG. 13.

FIG. 17 is a step diagram of an individualization plan builder procedure called from the procedures of FIGS. 13 and 21.

FIG. 18 is a step diagram of an individualization plan viewer procedure called from the procedure of FIG. 13.

FIG. 19 is a step diagram of a lesson plan procedure called from the procedure of FIG. 14.

FIG. 20 is a step diagram of an assignment procedure called from the procedure of FIG. 14.

FIG. 21 is a step diagram of a K12 builder procedure called from the procedures of FIGS. 14 and 20.

FIG. 22 is a step diagram of a plan viewer procedure called from the procedure of FIG. 14.

FIG. 23 is a step diagram of a grade book procedure called from the procedure of FIG. 14.

FIG. 24 is step diagram of a view grades procedure called from the procedure of FIG. 23.

FIG. 25 is a step diagram of a view citizenship grades procedure called from the procedure of FIG. 23.

FIG. 26 is a step diagram of an edit assignment grades procedure called from the procedure of FIG. 23.

FIG. 27 is a step diagram of a view grades by student procedure called from the procedure of FIG. 23.

FIG. 28 is a step diagram of an add comments procedure called from the procedure of FIG. 23.

FIG. 29 is a step diagram of a set grading periods procedure called from the procedure of FIG. 23.

FIG. 30 is a step diagram of an on-line testing procedure called from the procedure of FIG. 14.

FIG. 31 is a step diagram of a schedule test procedure called from the procedure of FIG. 30.

FIG. 32 is a step diagram of a view test schedules procedure called from the procedure of FIG. 30.

FIG. 33 is a step diagram of a view/score tests procedure called from the procedure of FIG. 30.

FIG. 34 is a step diagram of a build test procedure called from the procedure of FIG. 30.

FIG. 35 is a step diagram of a create new test procedure called from the procedure of FIG. 34.

FIG. 36 is a step diagram of a test questions procedure called from the procedure of FIG. 35.

FIG. 37 is a step diagram of a multiple choice procedure called from the procedure of FIG. 36.

FIG. 38 is a step diagram of a true/false procedure called from the procedure of FIG. 36.

FIG. 39 is a step diagram of a yes/no procedure called from the procedure of FIG. 36.

FIG. 40 is a step diagram of a short answer procedure called from the procedure of FIG. 36.

FIG. 41 is a step diagram of an essay procedure called from the procedure of FIG. 36.

FIG. 42 is a step diagram of a work sample procedure called from the procedure of FIG. 36.

FIG. 43 is a step diagram of a save procedure called from the procedures of FIGS. 37, 38, 39, 40, 41 and 42.

FIG. 44 is a step diagram of a procedure used to questions being saved from FIG. 43.

FIG. 45 is a step diagram of a search item bank procedure called from the procedure of FIG. 44.

FIG. 46 is a step diagram of a copy procedure called from the procedure of FIG. 4.

### DETAILED DESCRIPTION OF THE INVENTION

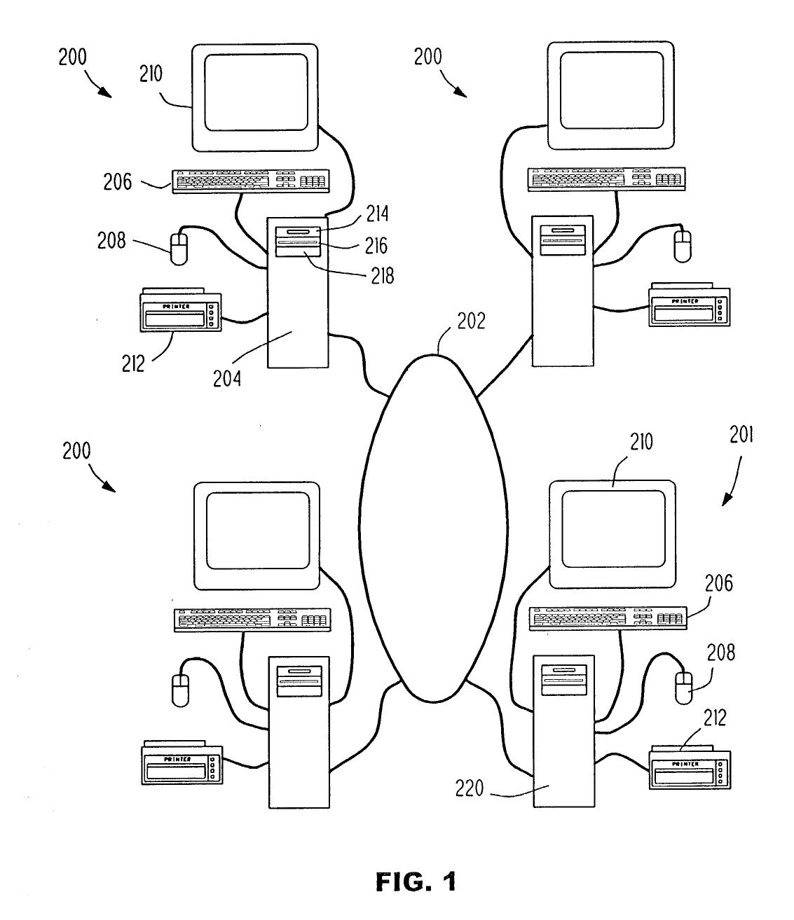

As shown in FIG. 1, an educational management system in accordance with one embodiment of the invention is employed in a computer network having a plurality of computer stations 200 along with a server station interconnected by a network 202. Each computer station 200 typically includes a central unit 204 which is connected to a keyboard 206, mouse 208, monitor 210 and printer 212. The central unit 204 typically includes a read/write removable media device such as floppy disk drive 214, a read only removable media device such as a CD-ROM or DVD reader (or reader/writer) 216 and a mass storage device such as a hard drive 218. The server station 201 is similar to the computer stations but has a server unit 220 which contains storage units for holding a large quantity of files which are accessed by the computer stations 200 through the network 202

The network 202 in one preferred embodiment is the world wide web (sometimes called the internet) but could alternatively be one of a variety of other possible network configurations. Where the educational management system is employed in a single school or closely distanced schools, the network 202 can be a hardwired internal network or connected through dedicated lines (sometimes called an intranet).

The educational management system is formed by one or more software programs which control and operate the computers 200 and server 201. The educational management system is organized in terms of five major components a community component, which governs what users at various levels can do in the system; a library component, which stores content in the system, a search and retrieval component, which enables searching within the system, a services component, which controls the various services provided through the system, and a time component, which controls when information and services are available to users.

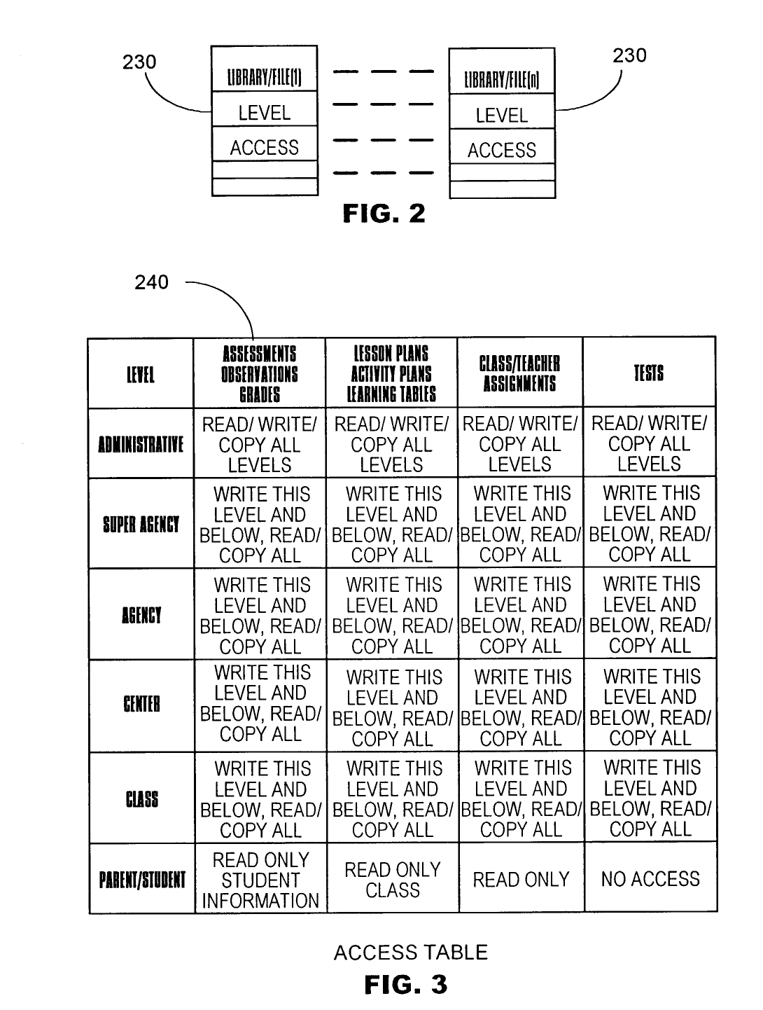

As described in U.S. Pat. No. 6,322,366 the educational management system employs a plurality of files/libraries 230, FIG. 2, such as libraries containing source materials for lesson plans, activities, tests, observational scales, learning capabilities, etc., files containing organization information including agencies, centers (schools), classes, students, family information, etc.; and student achievement information such scores, grades, notes, etc. The educational management system provides for a plurality of levels of access to the files including administrative level, super agency level, agency level, center level, class level and parent/student level. These levels are hierarchical levels that control the generation and deployment of information in the system. For example, certain information generated at higher levels in the system is made available instantaneously on a read-only basis to users at lower levels in the system. Likewise, information generated at the lower levels may be made available to users at higher levels in the system. Top-down deployment provides rapid access to information that has been newly generated or updated and subsequently approved for distribution. Bottom-up deployment provides information to guide administrative and supervisory activities. Accessability is also based on the level at which the information is created. For example assessment scales may be generated at any of the administrative, super agency, agency, center and class levels but an assessment scale entered at one of these levels can not be modified by a user in another level. Flexibility of use is achieved by including copy routines which enable a user at one level to copy read-only material from another level to a new file which can then be edited to generate a modified file at the one level. The system of hierarchical levels is considered the community component of the educational management system. An example of the assess accorded these levels is set forth in the table 240 in FIG. 3.

The highest level in the community component is the system administration level. This level provides universal access to information in the system and control of all services provided in the system. Information generated at the administrative level is available on a read-only basis to all users in the system. For example, assessment scales entered at the administrative level are available on a read-only basis to users in all lower levels, i.e., users who do not have administrative-level permissions cannot modify those scales created at the administrative level. The administrative level also includes services, which are not available to users at other levels. For example, system administration functions include the initial assignment of user names and passwords to administrators in the administration level and the next lower super agency level. Such assignment of user names and passwords can be handled by an administrator in each level and/or in the next higher level.

The second level in the community component is the super-agency level. A super-agency is comprised of a number of agencies. For example, a State Department of Education could be assigned to the super-agency level. The various school districts in the state would be agencies included within the super-agency. Super-agency users can generate and deploy information to agencies within their super-agency. In addition, they may view information generated at the agency level or at lower levels in the system. For example, super-agency users may view student outcome data.

The third level in the community component is the agency level. Agencies are typically comprised of a number of centers. For example, a school district may contain several schools, each of which could be classified as a center in the system. Users at the agency level can generate and disseminate information to users at lower levels in the agency. Likewise, agency level users can access information generated by centers within their agency. For example, a school district may generate and/or update curriculum materials, which are made available to all schools within the district. The district might also wish to view student outcome data for each of the schools within the district.

The fourth level in the community component is the center level. Centers are typically composed of classes. For example, administrators from a particular school might be assigned as center level users. Center level users can generate information, which is made available to classes within the school. In addition, they may view class level information. For example, a school principal might view student outcome data for students in a particular class in the school.

The fifth level in the community component is the class level. Teachers assigned as users at the class level may generate information to be disseminated to students. Likewise, they observe and evaluate student learning.

The final level in the community component is the parent/student level. The system provides parents and students information about learning opportunities, responsibilities, and accomplishments. For example, the system provides a development profile for parents indicating what their child has learned, what the child is ready to learn, and what the child will be ready to learn later. Parents can use this information to support learning in the home environment. The system also affords parents and students the opportunity to communicate with teachers electronically through e-mail.

Educational content in the system is made available through libraries. There are several types of libraries. For example, there are libraries that contain lesson plans. There are libraries of observational scales and libraries of tests. There are also libraries that contain learning activities articulated to educational goals established for the system. Libraries are linked to community components. This linkage controls the generation and deployment of content in the system. The level of the community component selected for library generation plays a major role in determining how broadly or narrowly content in the library will be deployed. For example, a library generated at the agency level would contain content available not only to the agency, but also to centers and classes within the agency. By contrast, a library generated at the class level would contain content available only to members of that class.

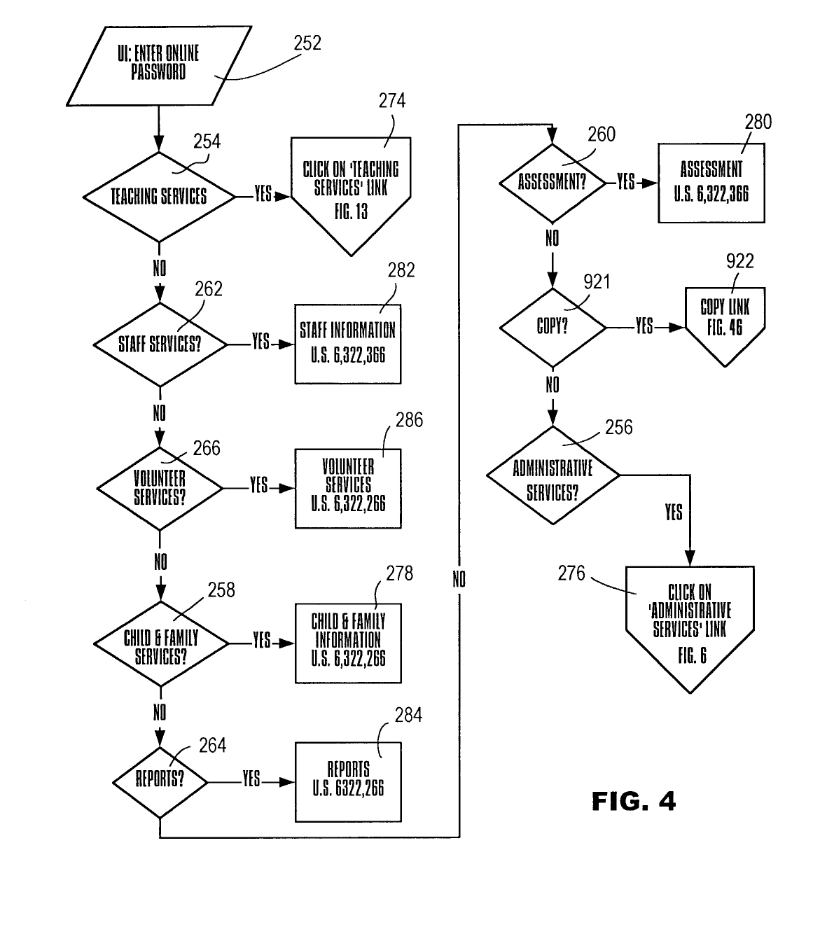

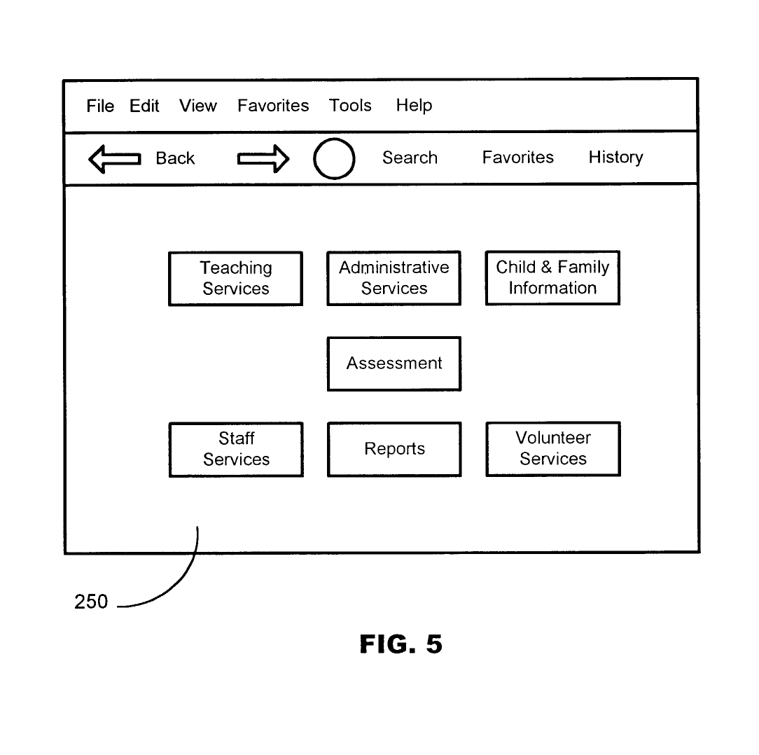

The management capabilities of the system are rendered through a series of software services. There are currently two levels of service in the system: Services rendered at the infancy to preschool level and K-12 services, which include services designed for use from kindergarten through the 12^{th} grade. The following types of services are offered in the system: administrative services, teaching services, assessment services, reporting services, child and family information services, staff and volunteer services, and online help. After the educational management system is activated, for example by accessing an world wide web address, these services are called via the network such by clicking on a browser page 250 illustrated in FIG. 5. Initially, a user accessing the educational management system must enter a valid user name and password, step 252 in FIG. 4, before the browser screen of FIG. 5 appears. Selection of one of the items, teaching services, administrative services, child and family services, assessment, staff services, reports or volunteer services results in the corresponding step 254, 256, 258, 260, 262, 264 and 266 calls the corresponding procedures through links 272, 274, 276, 278, 280, 282, 284 and 286. Reference is made to U.S. Pat. No. 6,322,366, U.S. patent application Ser. No. 09/558,060 and U.S. patent application Ser. No. 09/628,806 for a detailed description and illustration of various procedures involved in providing these services. The present disclosure supplements the description and illustration of U.S. Pat. No. 6,322,366.

Within each category type, specific services are offered depending on the level of community component to which the user is assigned. The administrative services area within the application is where basic information about the program is recorded. Program information includes information about the agencies, centers, and classes comprising each program, program users, teachers, children, and children's families within the community component. Services available within the administrative services category are:

1) Agency, center, class, and teacher assignment. This service gives users the opportunity to enter basic information about the organizational structure of an educational program. For example, a user logged in at the agency level of the community component may create centers, classes, and teachers. They may then assign classes and teachers to centers and classes.

2) Child listing and enrollment. This allows for the creation of student records and assignment of these records to individual classes. The process for accomplishing this is to create the student record (and class record) first, then assign the student record to the appropriate class. Teachers are assigned to classes in the same manner. One of the major problems facing educational organizations concerned with documenting outcomes is the ability to follow students longitudinally as they move from one class, center, or agency to another. This approach taken to child management in the educational management system facilitates longitudinal tracking of students.

3) Family member listing. This allows the user to enter family members of students and to record detailed information about the families of students. It is well known that families play a critical role in student learning. The educational management system provides the ability for researchers and policy makers to gather information about the relationship between family characteristics and student learning. The security measures included in the community component of the system makes it possible to conduct research in this area in ways that protect the privacy of the families involved.

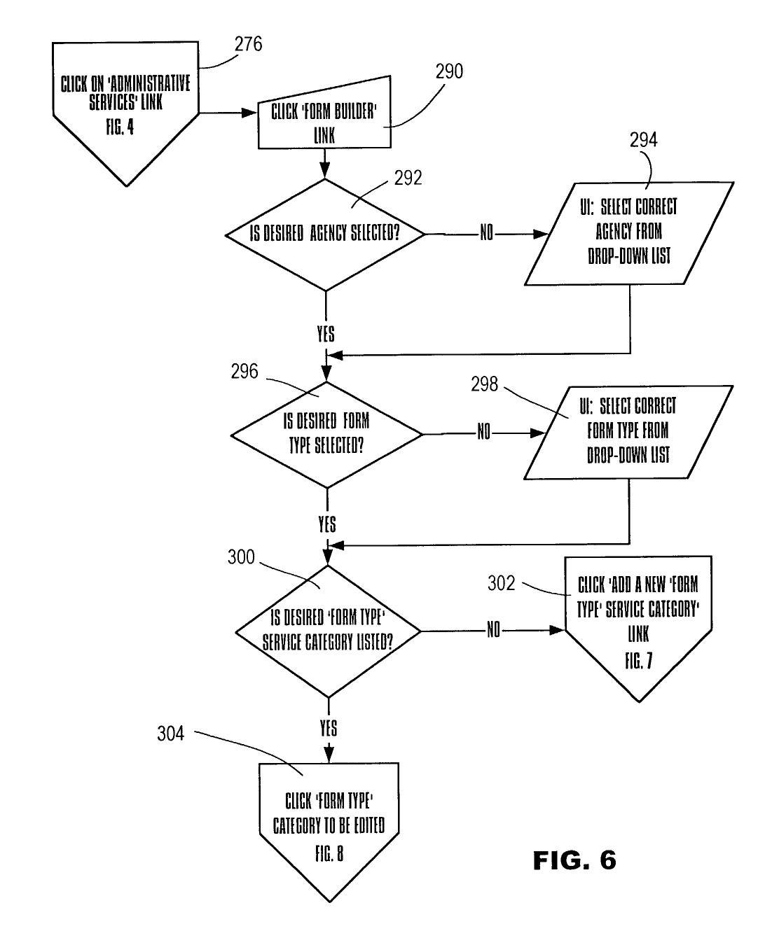

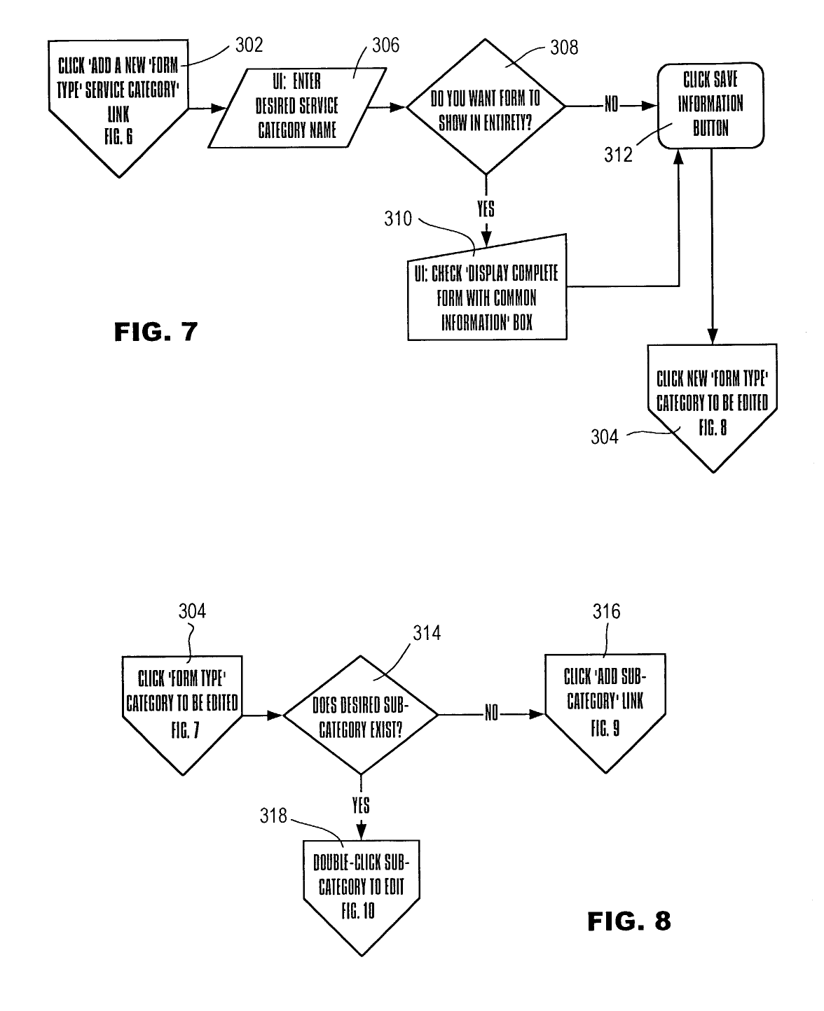

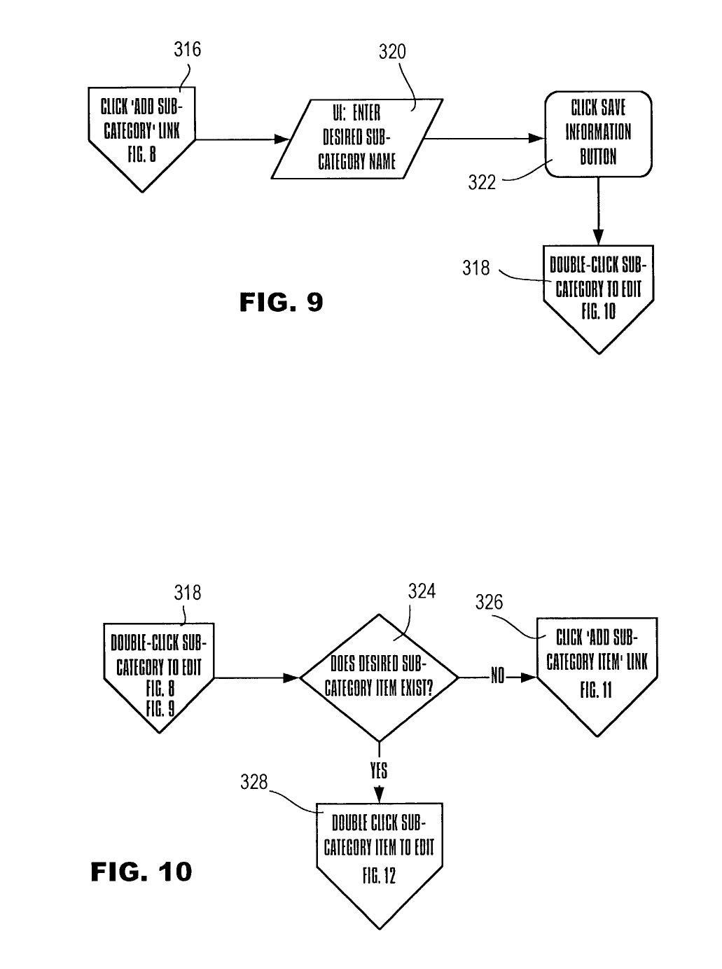

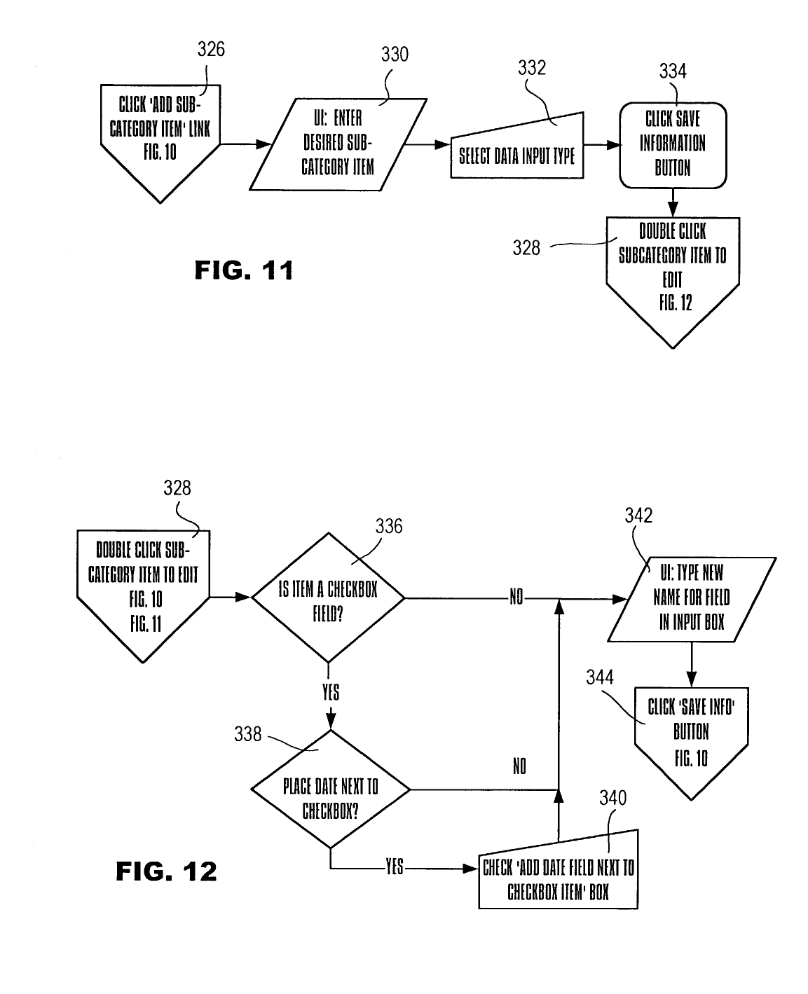

4) Form building service. A part of program illustrated in FIGS. 6, 7, 8, 9, 10, 11 and 12 allows users to create extended data fields, which are then tracked longitudinally as a part of the time component. Through a form builder procedure called at 290, FIG. 6, the program can create or modify various forms. In steps 292 and 294, the agency can be selected or changed. In steps 296 and 298 the type of form such as child, family, staff, and volunteer forms is selected. For example, these forms can be created to articulate to local, state, or federal reporting requirements. Within a particular form, form builder at step 300 allows the user to create, link 302, or modify, link 304, the category (title) of information included on the form. In the procedure of FIG. 7 called by link 302, a new service category name is entered by the user. At steps 308 and 310 it is determined if the user wishes to show the form in a window. After selecting a listed category in the procedure of FIG. 6 or 7, the procedure of FIG. 8 in step 314 lists subcategories, if they exist, under the selected category. clicking on add a subcategory calls the procedure of FIG. 9 through link 316 and double clicking on a listed category calls the procedure of FIG. 10 through link 318. In the procedure of FIG. 9, one or more subcategories can be added in steps 320 and 322. For example, a program that wishes to track medical information pertaining to children can design a custom form and designate the specific information that will be included on the form. The extended information included on these forms becomes a part of the time component, meaning that changes over time in this information can be tracked. Calling the edit subcategory procedure of FIG. 10 either from FIG. 8 or FIG. 9 results in step 324 listing items, if any, under the selected category. Items can be added to the list through link 326 to the procedure of FIG. 11 or double clicking on a listed item links though step 328 to the procedure of FIG. 12, In FIG. 11, new subcategory items and data types are entered in the list by steps 330, 332 and 334. Possible data types include checkbox, date, text, memo, number or option (drop box list). The item editing procedure of FIG. 12 is called by double clicking on a selected item. In step 336, it is determined if the item is a checkbox and, if true, the option of adding a date field next to the check box is provided in steps 338 and 340. In step 342, a new name may be entered for the field. saving the enter or modified item information in step 344 also returns to the procedure of FIG. 10.

5) Data transfer. A central feature of the time component, data transfer allows the user to carry over teacher, class, and child information from one record year to the next.

Services available in the teaching services category are different for the preschool and K-12 levels, depending on the type of agency each user is assigned to in the community component. At the preschool level, teaching services are divided into the following categories:

1) Lesson Planning. This is made up of:

a) Plan Builder. Plan builder is the source from which teachers select activities to create lesson plans.

b) Library Builder. This is where users can access and organize stores of lesson plans—this is a key part of the library component.

c) OTL (Opportunity to Learn) Lesson Plan Maps. These maps link lesson plans to goals. An OTL Map shows the class plans for each goal for any given developmental area. Goals are ordered by difficulty. OTL Lesson Plan Maps are useful for determining the extent to which class plans are providing adequate learning opportunities in a selected developmental area. To view a map, a user selects a class containing the lesson plans of interest. The user next selects a developmental area. When a developmental area is selected, the user may open a window to view the map for the selected area. Individual lesson plans included in the Map can be accessed directly from the Map. While other instructional management systems assist teachers in comparing lesson plans to educational standards and goals, this educational management system is unique because this action is carried out automatically for users within the system. Other systems require manual comparison and extraction of standard-satisfaction.

2) Activities. Activities are made up of:

a) Library Builder This is where users name an activity library prior to populating it with activities. In this instance, users apply the library component to create a library in which to store a list of activities to be used in the instruction process.

b) Activity Builder. Once a library has been named and saved, activity builder is used to populate it with activities. Activities will specify the class area/activity location, and will have goals and provide instructions to be incorporated into lesson plans.

c) OTL (Opportunity to Learn) Maps. These are similar to the OTL Maps section in Lesson Plans.

d) Activity Viewer. This feature allows the user to work with and view in detail the components of any individual activity.

3) Activity Location. This is made up of:

a) Class Area Builder This is a function used to create lists of classroom areas available for use during activities.

b) Library Builder. Library Builder contains the lists of classes (libraries) from which a user may select.

c) Copy Class Areas. This is the function used to select class areas from one library to another. This feature is useful when multiple classes share the same physical classroom, e.g. morning and afternoon sessions in a preschool.

4) Individualization. This is a feature intended to ensure children with specialized needs (either less or more advanced than their peers) are considered in lesson planning. The Individualization feature allows teachers to plan lessons and activities for specific children, identifying skills as ready-to-learn and tracking progress at the individual level rather than subjecting all students in a class to a common denominator.

5) Attendance. Attendance consists of a section for attendance tracking at the class level and a section for meal count.

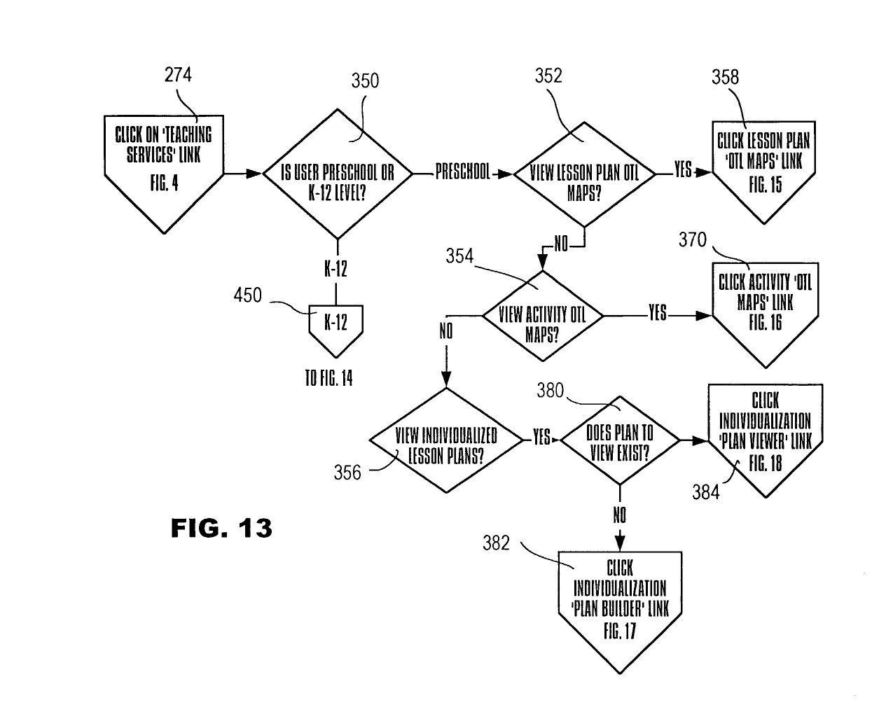

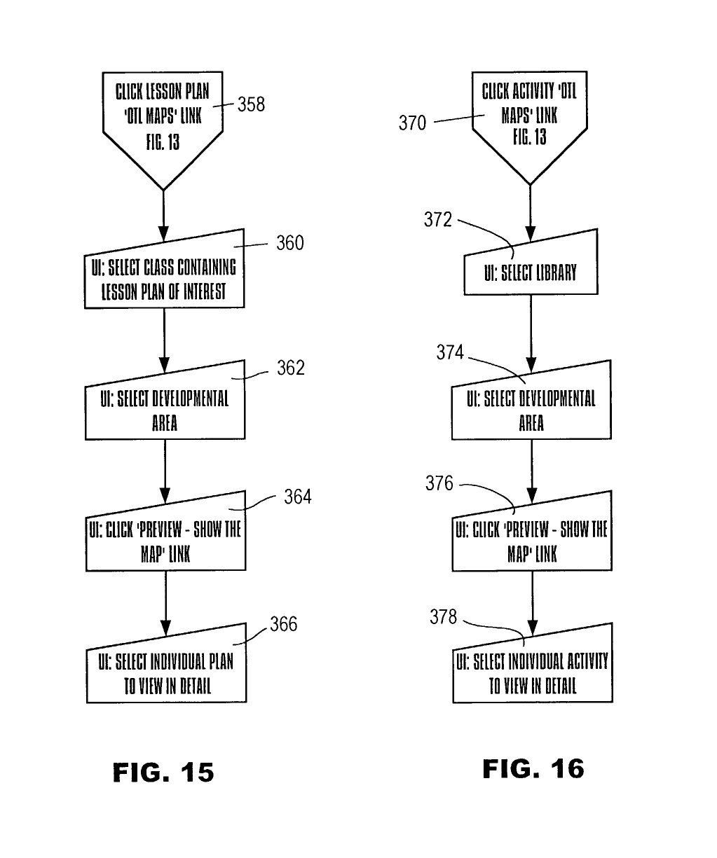

Calling the teacher services procedure of FIG. 13 results in step 350 determining if the user is preschool or K-12. Preschool or K-12 is selected by the user when initially logging on to the educational management system. If preschool, the user can select lesson plan map view in step 352, activity map view in step 354 or individual lesson plan in step 356. If lesson plan map view is selected link 358 calls the procedure of FIG. 15 where the user selects the class to which the lesson plan is assigned in step 360, selects the developmental area of interest in step 362, displays the map which is a listing of goals within the developmental area together with a listing of lesson plans for each goal, and in step 366 can select and view in detail one of the listed lesson plans. Similarly for selection of viewing activity OTL maps, link 370 calls the procedure of FIG. 16 where the user selects the library to which the activity is assigned in step 372, selects the developmental area of interest in step 374, displays the map which is a listing of goals within the developmental area together with a listing of activities for each goal, and in step 366 can select and view in detail one of the listed activities.

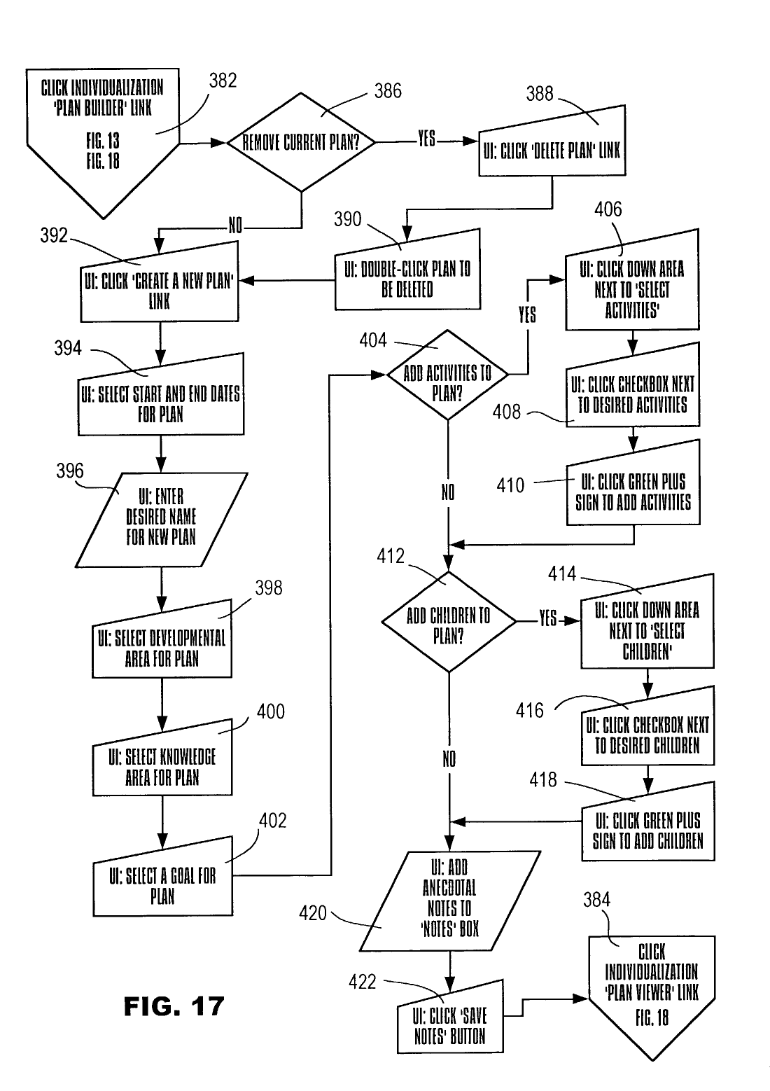

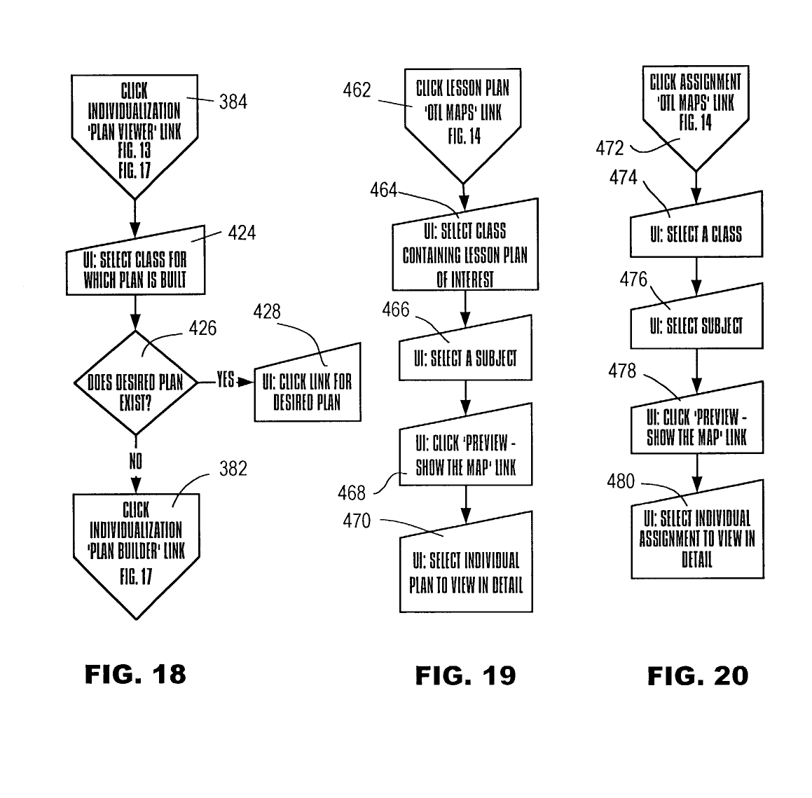

After individualization is selected in step 356 of FIG. 13, step 380 determines of the selected class contains individualized plans and if so lists the plans. The user has the choice of building a new plan by selecting link 382 to the procedure of FIG. 17 or viewing a plan, if the plan exists, by selecting link 384 to the procedure of FIG. 18. In the plan builder procedure of FIG. 17, step 386 determines if there is a listing of plans, and if true, permits the user to select delete plan in step 388 and to select the plan to be deleted in step 390. In step 392 the user can click on create a new plan which permits the user to select start and end dates in step 394, enter a name for the plan in step 396, select the developmental area for the plan in step 398, select the knowledge area for the plan in step 400 and select a goal for the plan in step 402 from a listing of the goals in the selected knowledge area. In step 404, the user can select to add activities to the plan and if true steps 406, 408 and 410 are used to list, select and add one or more activities to the plan. Similarly the user in step 412 can elect to add children to the plan, and if true, steps 414, 416 and 418 are used to list select and add one or more children from a list of children in the class to the plan. Step 420 is used to add notes to the plan and step 422 is used to save the plan. Calling the plan view procedure of FIG. 18 from either the procedures of FIGS. 13 or 18, enables the user to in step 424 to select a class whereupon the procedure in step 426 lists the plans, if any, for the selected class and in step 428 permits the user to select and view a listed plan. The user in the procedure of FIG. 18 can also call the plan builder routine of FIG. 17.

K-12 teaching services provide services to educational programs serving students from kindergarten through the 12^{th} grade. K-12 services include services available at the preschool level and additional services related to lesson planning, student assignments, and grades.

1) K-12 Lesson Plans. Lesson planning services at the K-12 level enable the user to record daily lesson plans. A unique feature of K-12 Lesson Plans is that they require the user to specify lesson plan goals, which can be directly linked to educational standards. Standards, in turn, are linked to user-defined scales to assess learning outcomes on a continuous basis in educational programs.

2) Assignments. The K-12 level of the system makes it possible for teachers to create student assignments and post them online. The specification of goals is required for assignments as it is for lesson plans. As a consequence, the student always knows the way in which an assignment contributes to the mastery of standards.

3) OTL Maps. OTL Maps are provided for K-12 lesson plans and for assignments. These maps show the links between lesson plans and goals and assignments and goals. Reviewing OTL Maps indicates the extent to which assignments and lesson plans adequately reflect the broad range of standards that may be associated with a particular subject.

4) Grade Book. The grade book enables the teacher to assign grades to student performance and to post grades. The Grade Book function of the educational management system is unique in that assignment of grades includes the capability to grade the achievement of educational goals & standards For example, in assigning a grade, a teacher has the option of checking that a particular standard has or has not been met. This approach provides a continuous record of student progress related to the achievement of standards. Standards are incorporated into scales. The psychometric properties of the scales are established using item-response theory. The result is the creation of local scales using psychometric procedures typically used only in establishing the psychometric properties of standardized test. This feature makes it possible to compare student performance on standardized test to performance on local measures reflecting performance in the context of the school setting. Schools often question the validity of statewide testing programs, charging that these programs do not adequately reflect student learning. The ability to generate psychometrically sound local measures directly from student grades provides a unique way for schools to gather the data required to determine the congruence between what is learned in school and what is measured on standardized tests

6) K-12 Assessment Services. K-12 assessment services include all of the features of assessment included in the earlier patent application. In addition, a number of new features have been added. The current version includes a new history feature, which makes it possible to determine student capabilities at any point during an observation period. For example, if a teacher wished to know what had been recorded regarding a particular student's learning as of a particular date, the teacher could set the date to the date in question and the observation screen would display what the student had learned as of that date.

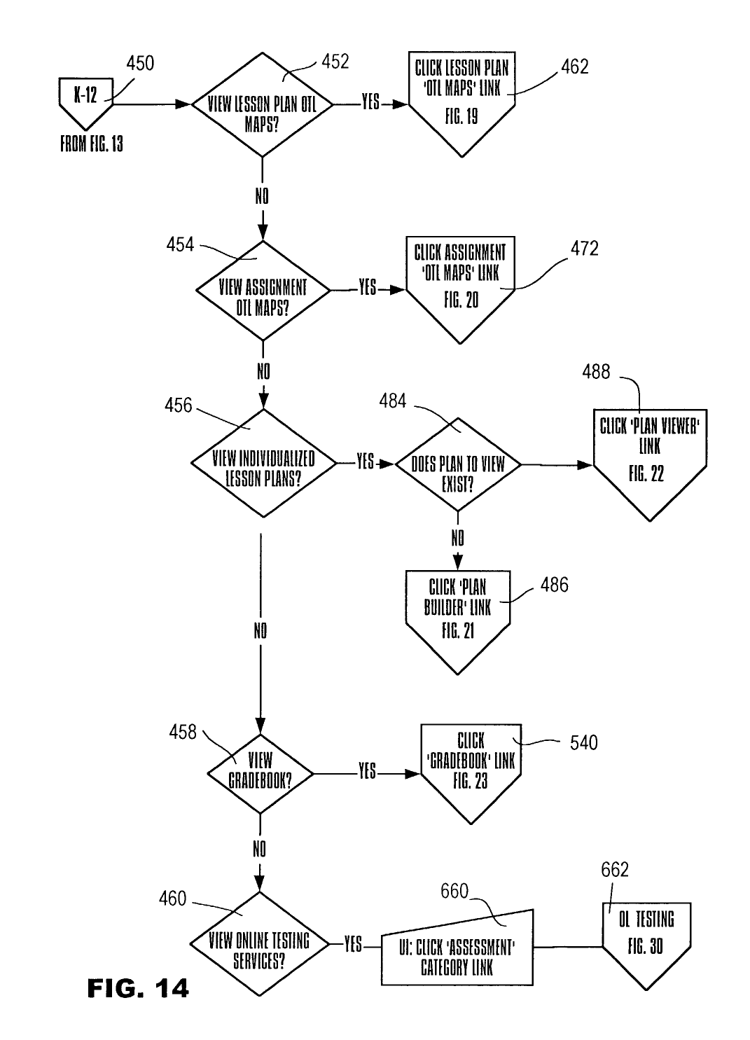

If the K-12 environment is found or selected in step 350 of FIG. 13, link 450 calls the procedure of FIG. 14. The user has the options of selecting to view lesson plan maps in step 452, to view assignment maps in step 454, to call individualized lesson plans in step 456, to view the grade book in step 458 and to call on-line testing services in step 460. If viewing lesson plan maps is selected in step 452, link 462 calls the procedure of FIG. 19 where step 464 permits the user to select the class having the lesson plan of interest, step 466 permits the user to select the subject matter of interest, step 468 permits the user to show the lesson plan map which is a listing of lesson plans relating to the selected subject and step 480 permits the user to select one of the listed lesson plans and view the selected lesson plan in detail. If viewing assignment maps is selected in step 454, link 472 calls the procedure of FIG. 20 where step 474 permits the user to select the class having the assignment of interest, step 476 permits the user to select the subject matter of interest, step 478 permits the user to show the assignment map which is a listing of assignments relating to the selected subject and step 480 permits the user to select one of the listed assignments and view the selected assignment in detail.

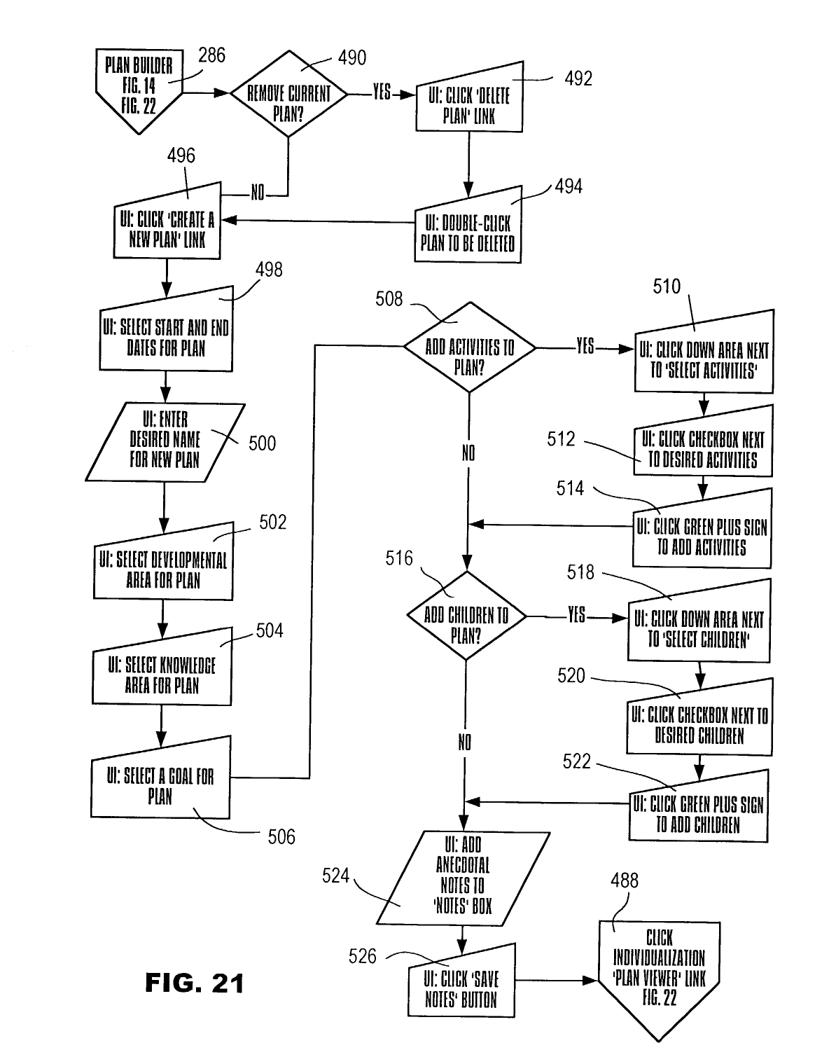

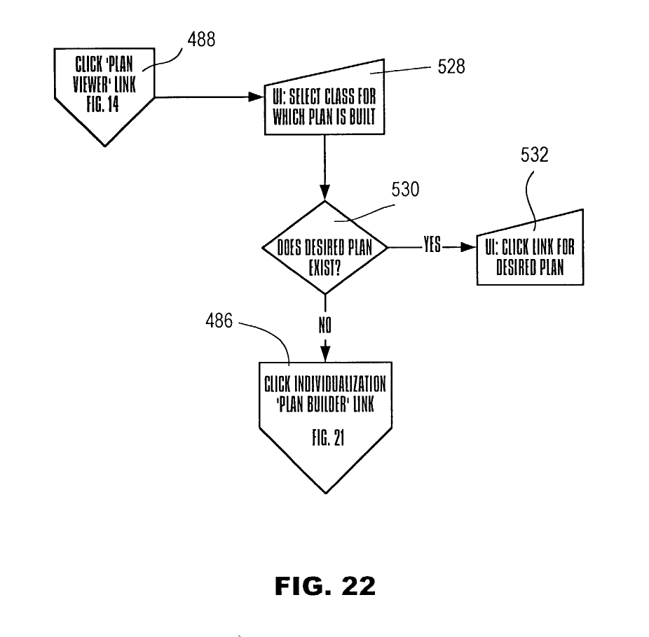

After individualization is selected in step 484 of FIG. 14, step 484 determines of there are individualized plans and if so lists the plans. The user has the choice of building a new plan by selecting link 486 to the procedure of FIG. 21 or viewing a plan, if the plan exists, by selecting link 488 to the procedure of FIG. 22. In the plan builder procedure of FIG. 21, step 490 determines if there is a listing of plans, and if true, permits the user to select delete plan in step 492 and to select the plan to be deleted in step 494 In step 496 the user can click on create a new plan which permits the user to select start and end dates in step 498, enter a name for the plan in step 500, select the developmental area for the plan in step 502, select the knowledge area for the plan in step 504 and select a goal for the plan in step 506 from a listing of the goals in the selected knowledge area. In step 508, the user can select to add activities to the plan and if true steps 510, 512 and 514 are used to list, select and add one or more activities to the plan. Similarly the user in step 516 can elect to add children to the plan, and if true, steps 418, 520 and 522 are used to list select and add one or more children from a list of children in the class to the plan. Step 524 is used to add notes to the plan and step 526 is used to save the plan. Calling the plan view procedure of FIG. 22 from either the procedures of FIGS. 14 or 21 by link 488, enables the user to in step 528 to select a class whereupon the procedure in step 530 lists the plans, if any, for the selected class and in step 532 permits the user to select and view a listed plan. The user in the procedure of FIG. 22 can also call the plan builder routine of FIG. 21.

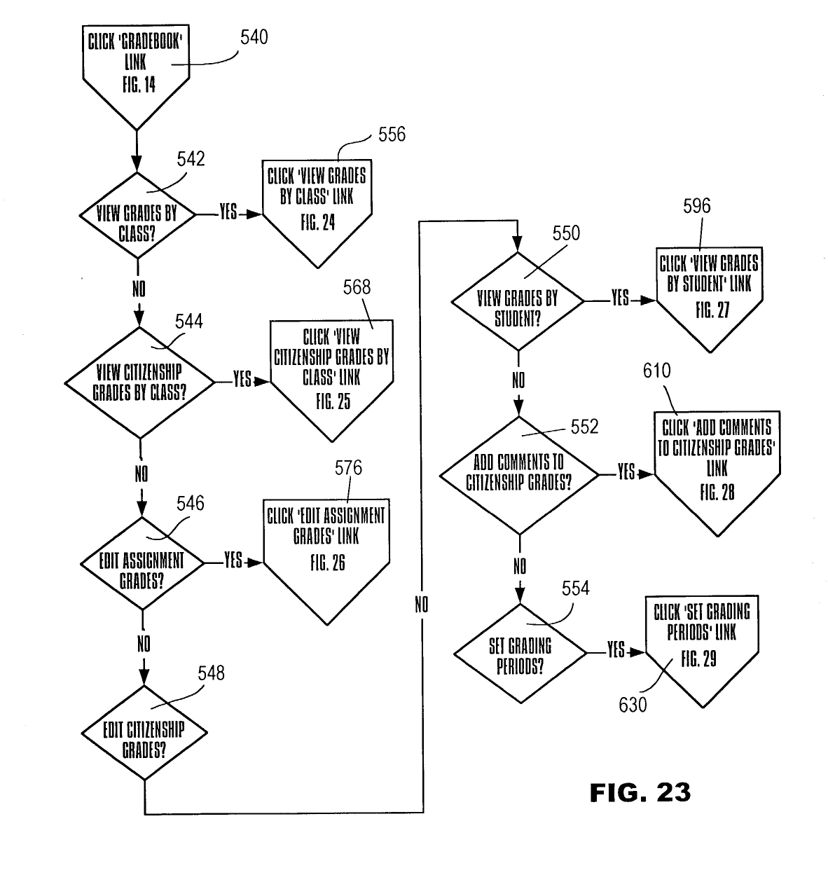

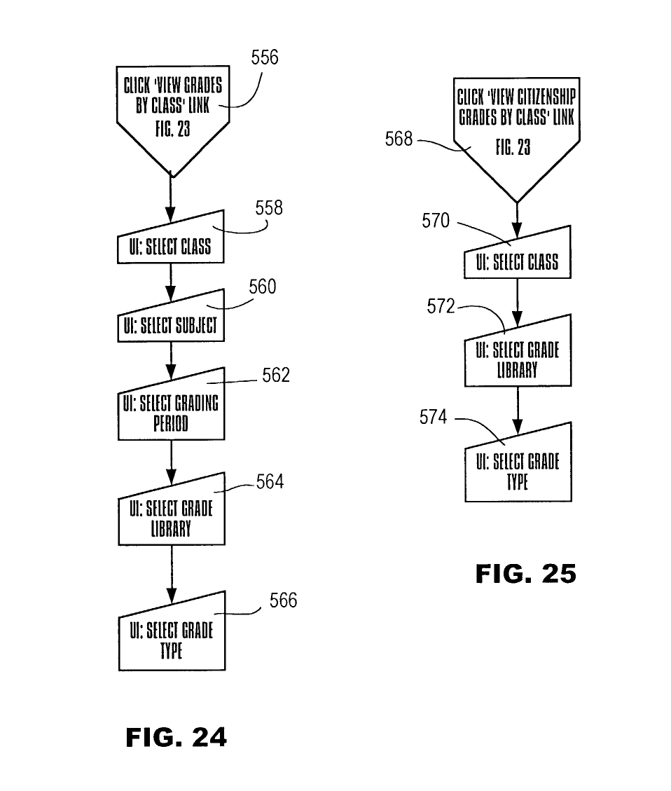

Selecting view grade book in step 458 results in link 540 calling the procedure of FIG. 23 wherein the user is presented displayed link names of view grades by class 542, view citizenship grades by class 544, edit assignment grades 546, edit citizenship grades 548, view grades by student 550, add comments to citizen ship grades 552 and set grading periods 554. Clicking on view grades by class results in link 556 calling the procedure of FIG. 23 wherein the user may select a class in step 558, select a subject in step 560, select a grading period in step 562, select a grade library in step 564 and select the grade type in step 566. The user by selecting various of the class (developmental area), subject (knowledge area), grading period, library (particular class) and type (grade) can produce views or reports that illustrates progress in achieving educational goals in various manners.

When view citizenship grades 544 is selected in FIG. 23, link 568 calls the procedure of FIG. 25. Steps 570, 572 and 574 enable the user to produce views or reports illustrating deportment of students based upon school, class and/or grade.

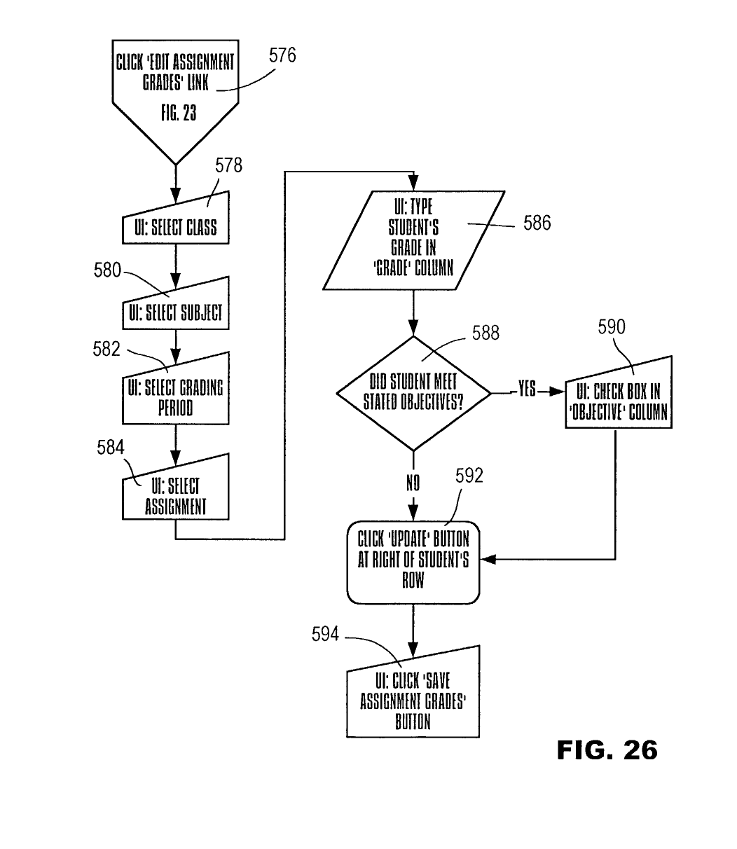

Clicking on the edit assignment grades results in link 576 calling the procedure of FIG. 26 wherein in the user selects the particular class in step 578, selects the subject in step 580, selects the grading period in step 580 and selects the assignment in step 584. A list of students in the class is displayed and the user (teacher) can enter grades in step 586 for each student. Additionally the user through steps 588 and 590 can indicate that a particular objective or goal has been achieved The students overall class grade is updated in step 592 and the entered and updated grades are saved in step 594.

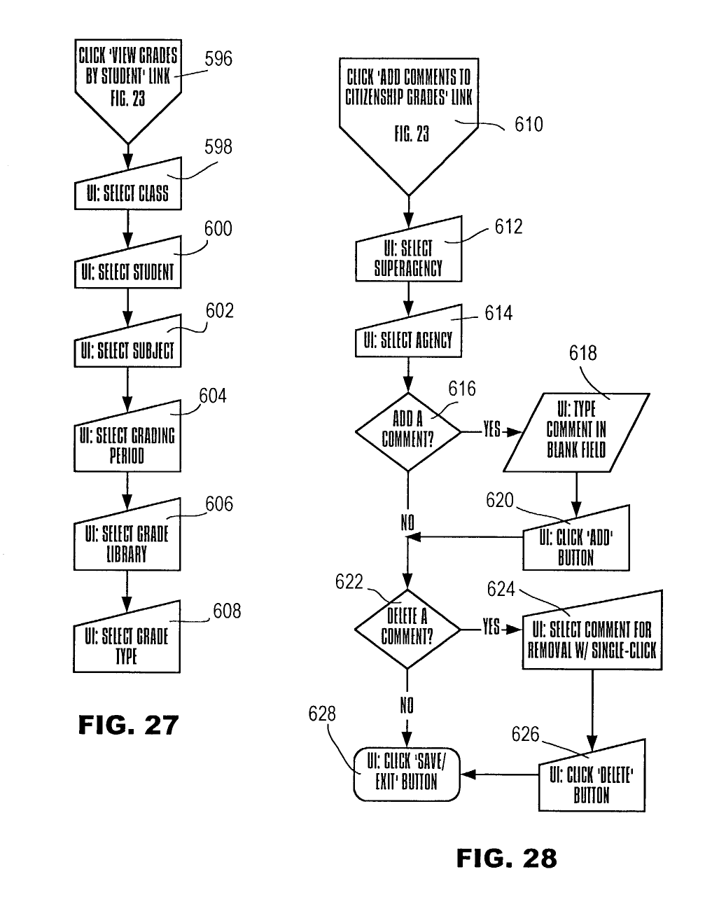

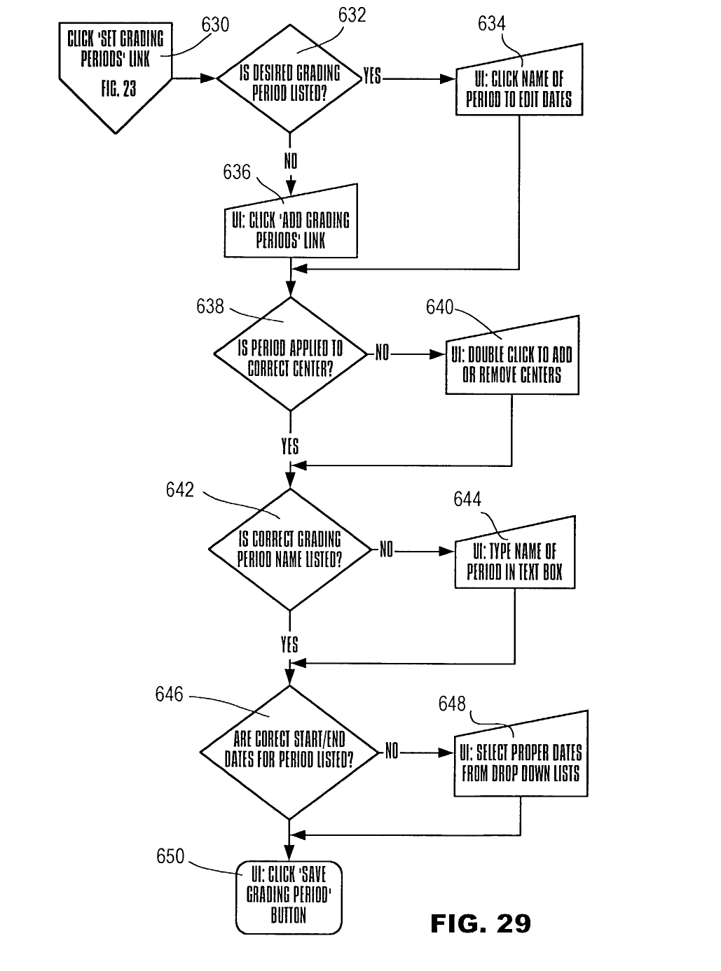

The grades of a particular student can be viewed by selecting view grades by student 550 whereupon the program by link 596 calls the procedure of FIG. 27. The user can then select a class in step 598, select a student in step 600, select a subject in step 602, select a grading period in step 606, select a grade library in step 606 and select a grade type in step 608 to generate a screen view or report of grades of the selected student.

Comments can be added to the citizenship grades by clicking on link 610 which calls the procedure of FIG. 28. In this procedure the user selects the superagency in step 612 and the agency in step 614. Step 616 enables the user to elect to add a comment by typing in a text box in step 618 and adding the comment by step 620. A comment can be deleted by clicking on a delete button sensed by step 622 to enable selection of a comment for deletion in step 624 and confirmation of the deletion in step 626. Changes in the citizenship comments for broadcast by the agency are saved in step 628.

Grading periods for centers (schools) are set by clicking on the set grading periods button or link name in step 554 of FIG. 23 whereupon link 630 calls the procedure of FIG. 28. Step 632 displays a list of grading periods and the user elects to edit a displayed desired grading period by clicking on a displayed grading period name in step 634 or elects to add a new grading period by clicking on an add grading period button in step 636 Steps 636 and 640 enable the user to change the listing of centers to which the grading periods apply while steps 642 and 644 enable the user to edit or enter the name of the grading period. The start and end dates of the grading period are changed or selected in steps 646 and 648. The modified or new grading period is saved by clicking on the save button in step 650.

Another set of new features involves the inclusion of an Online Test Development, Online Testing, and Online scoring feature. The Online Test development feature enables the user to construct tests involving a broad array of item types. The hierarchical structure of the community component described earlier makes it possible to deploy new tests constructed in the system rapidly to all selected users. Currently, States and local educational agencies are being encouraged to develop their own assessment systems to meet State and local accountability standards. A unique feature of the online test development feature is that newly constructed test items are linked directly to educational standards. Each new item is classified in terms of the standard or standards that it is designed to measure. Each standard represents a performance objective, which is linked to a knowledge area within a particular subject. The hierarchical classification of test items in terms of objectives nested within knowledge areas and subjects makes it possible to quickly produce an item bank in which items can be retrieved by specifying the subject, knowledge area, or objective with which they are associated.

The Online Testing feature makes it possible to administer locally designed assessment instruments online. Because of the way assessment instruments are constructed in the system, online testing can be used to assess student mastery of State and local standards.

The scoring feature associated with online testing provides automated scoring for multiple choice items, true-false items, and one-word answers. Scoring rules are provided for essay questions. It is also possible to scan in work samples and to link them to online tests for scoring purposes. This is accomplished by uploading files containing scanned in materials or other work done off line. A broad range of file types is accommodated ranging from bit maps and video files to wave files conveying audio recordings.

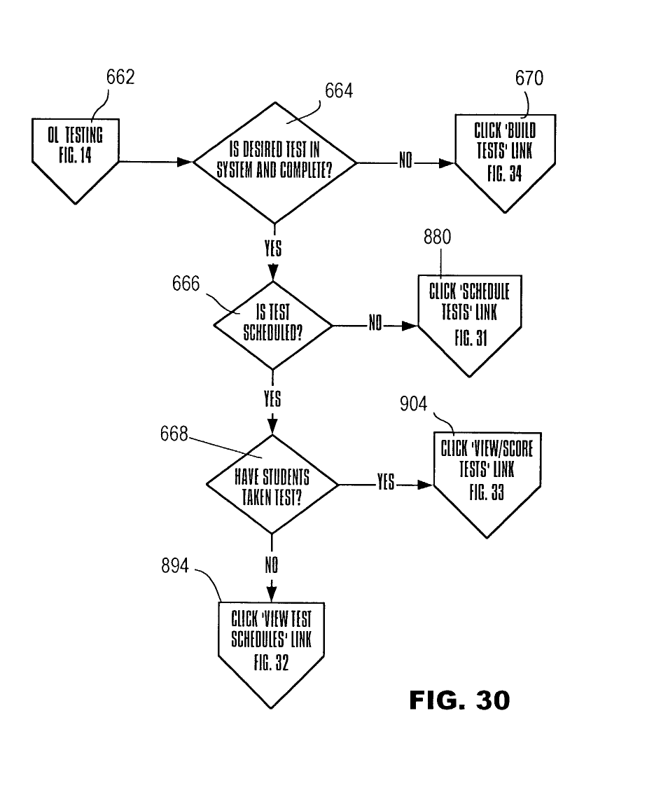

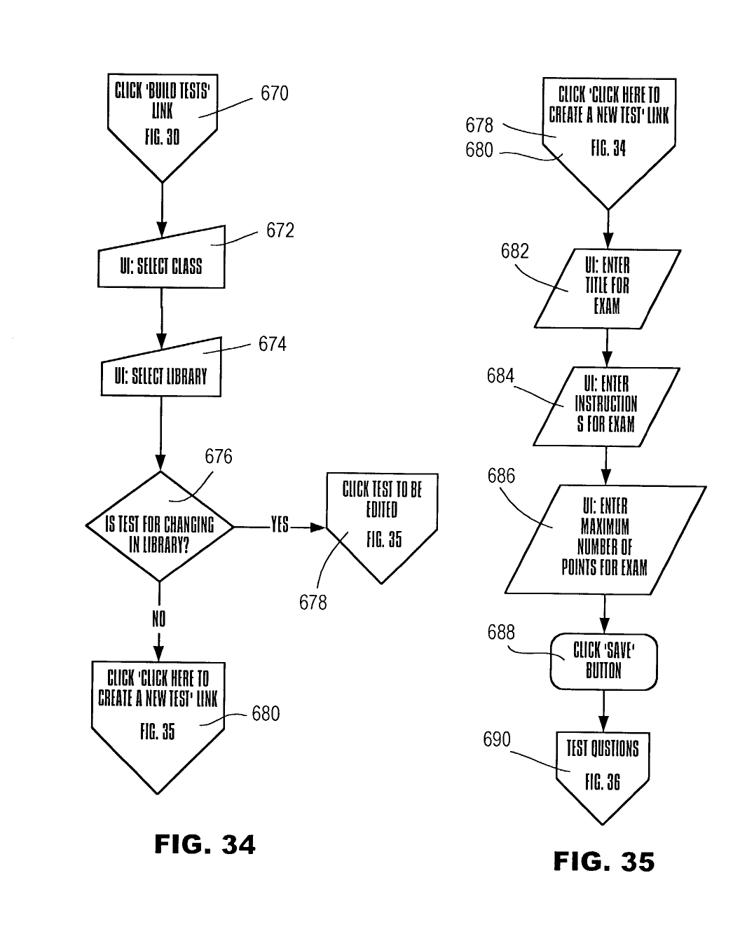

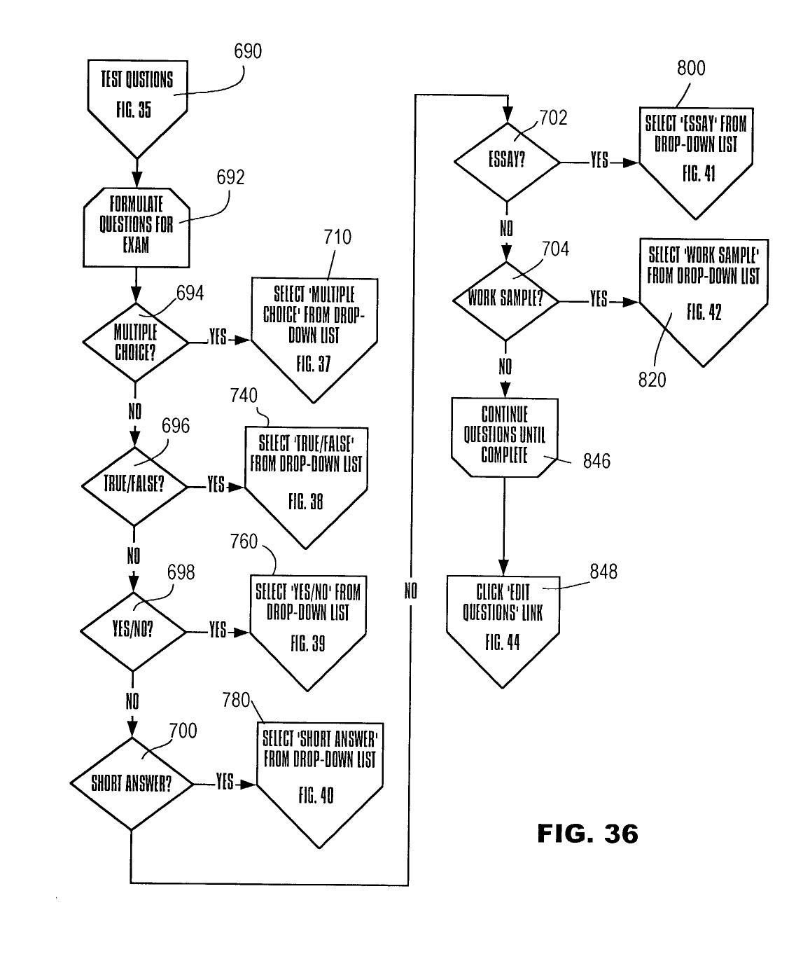

As shown in FIG. 14 the online testing services are called at step 460 via an assignment link 660 and link 662 to the procedure of FIG. 30. In this procedure the user is present several options depending upon whether one or more tests are in the system, step 664, tests are scheduled, step 666 and tests have been taken, step 668 If step 664 is false the only option is to select a build tests button having link 670 to the procedure of FIG. 34 where the user selects a class in step 672 and selects a library in step 674. In step 676 a list of names of tests, if any, in the selected library is displayed. A displayed name can be selected by clicking to activate link 678 or a create new test button can be clicked to activate link 680. Both links 678 and 680 call the procedure of FIG. 35 where step 682 enables entering or editing (if test selected in step 678) the title of the test or exam. Steps 684 and 686 permit the user to enter or edit exam instructions and the number of points for the exam. The new or modified information generated in FIG. 35 is saved by step 690 whereupon the program proceeds to the routine of FIG. 36 which enables formulation of exam questions beginning at step 692 The user selects type of question, multiple choice in step 694, true/false in step 696, yes/no in step 698, short answer in step 700, essay in step 702 or work sample in step 704.

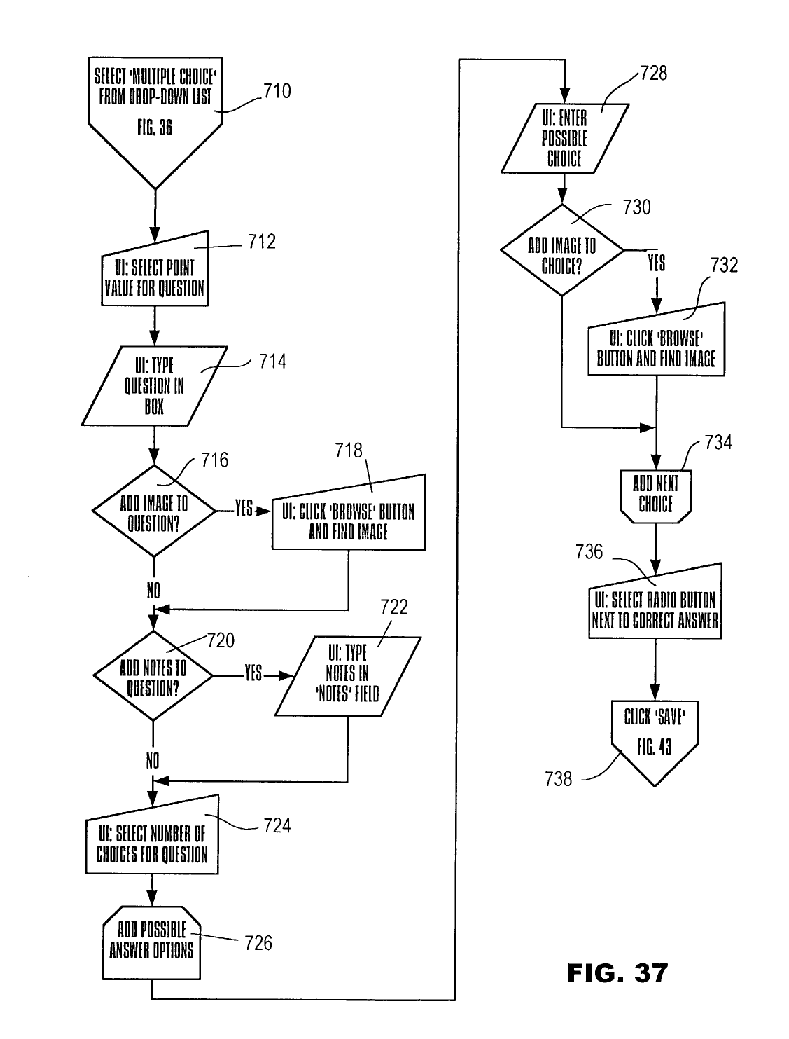

Selection of multiple choice results in link 710 calling the procedure of FIG. 37. In step 712 the point value of the question is entered and in step 714 the user types the question in a text box. If the user elects to add an image, step 716, to the question, step 718 provides a browse function to find and add the image to the question. Similarly the addition of a note to the question can be elected in step 720 and this note can be entered at step 722 in a text box. In step 724 the user enters the number of choices (possible answers) to be listed under the question to start a loop at point 726 wherein the possible choices are entered in step 728 and images can be added using steps 730 and 732. Step 734 returns to the beginning 726 of the loop until the number choices selected at step 724 are all entered. After completion of the choices, the user selects the correct answer in step 736 and saves the question and choices in step 738.

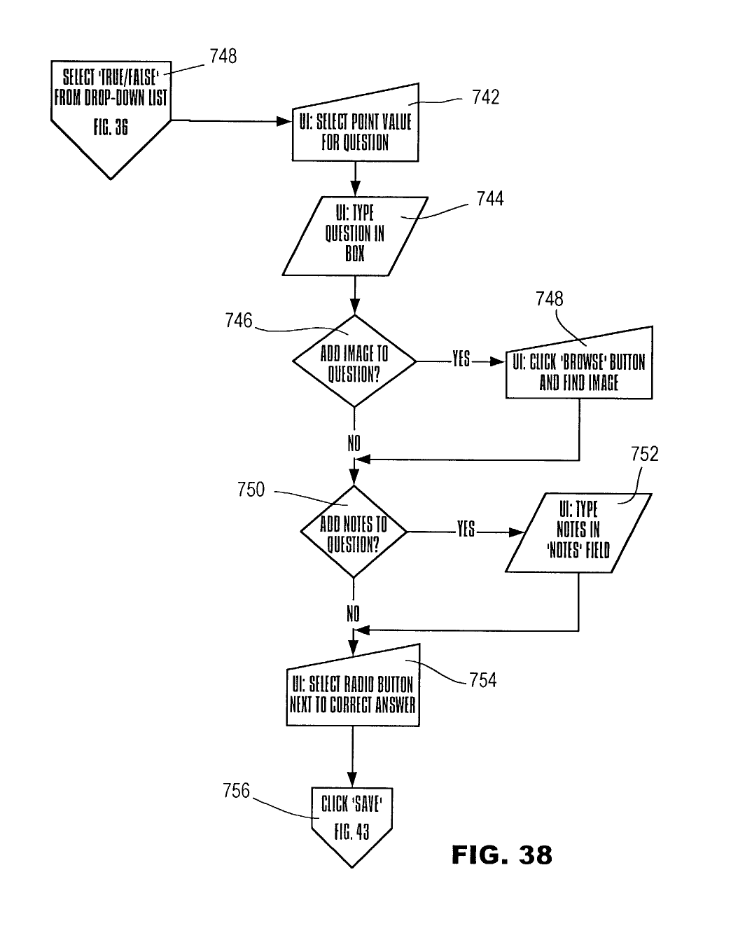

When the user elects to enter a true/false question, link 742 calls the procedure of FIG. 38 where the point value of the question is entered in step 742, the question is entered in a test box in step 744, an image can be added to the question using steps 746 and 748, and a note can be added to the question using steps 750 and 752. The correct answer is selected in step 754 and the question is saved in step 756.

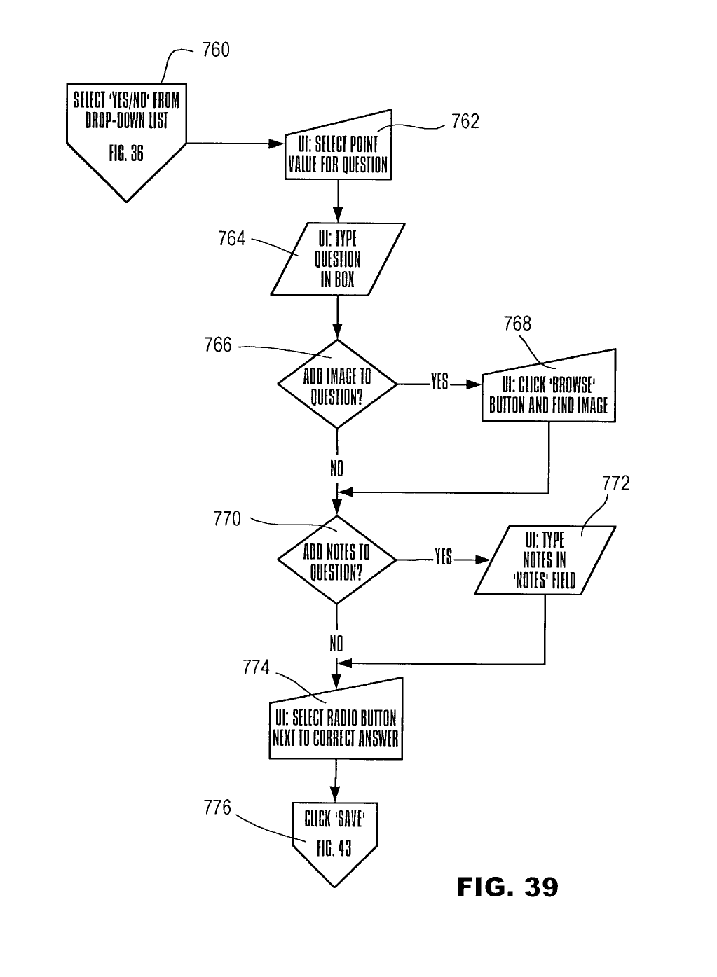

Similarly when a yes/no question is elected, link 760 calls the procedure of FIG. 39 where the point value of the question is entered in step 762, the question is entered in a test box in step 764, an image can be added to the question using steps 766 and 768, and a note can be added to the question using steps 770 and 752. The correct answer is selected in step 774 and the question is saved in step 776.

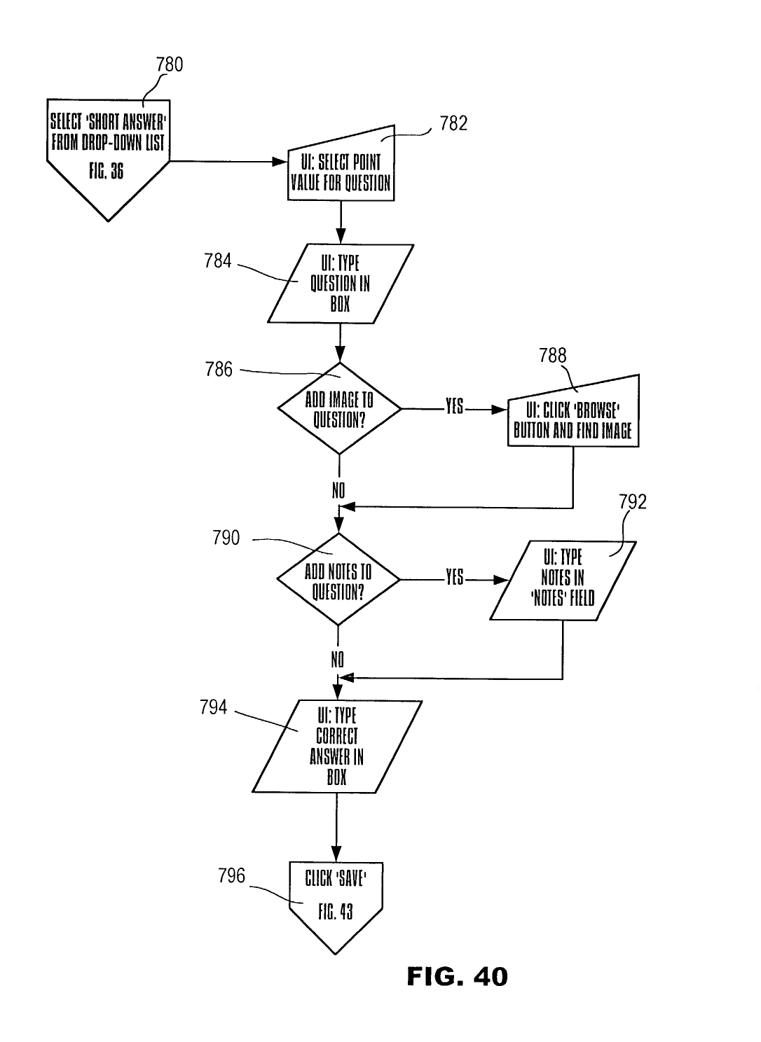

Election to enter a short answer question results in link 780 calling the procedure of FIG. 40. The point value of the question is entered in step 782, the question is entered in a test box in step 784, an image can be added to the question using steps 786 and 788, and a note can be added to the question using steps 790 and 792 The correct answer is typed in a text box in step 794 and the question is saved in step 796.

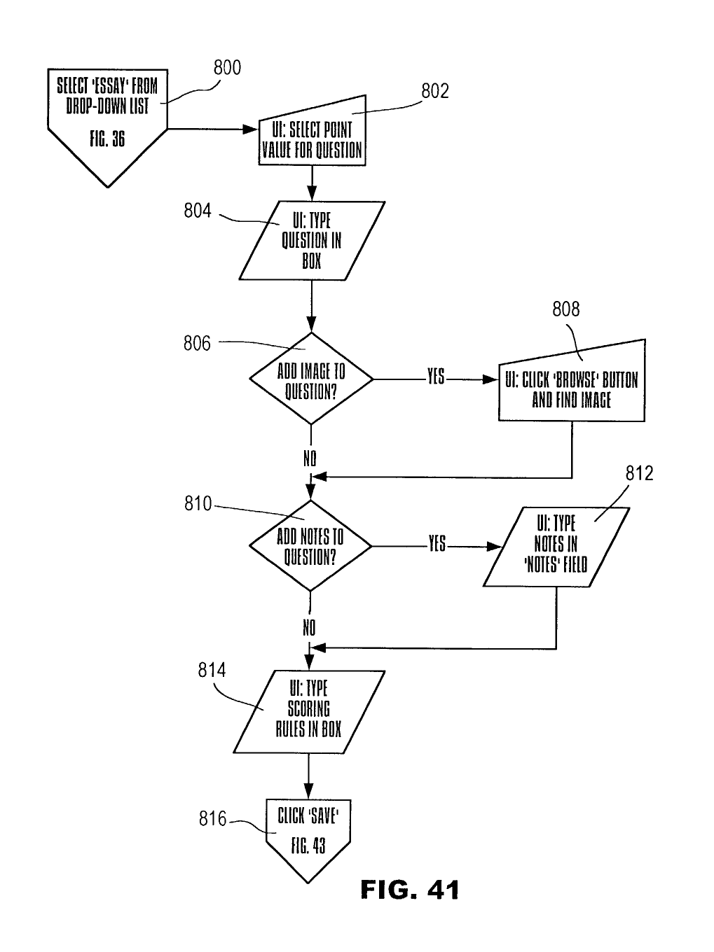

Clicking on the choice to enter an essay question results in link 802 calling the procedure of FIG. 41. The point value of the question is entered in step 802, the question is entered in a test box in step 804, an image can be added to the question using steps 806 and 808, and a note can be added to the question using steps 810 and 812 The scoring rules are entered in a text box in step 814 and the question is saved in step 816.

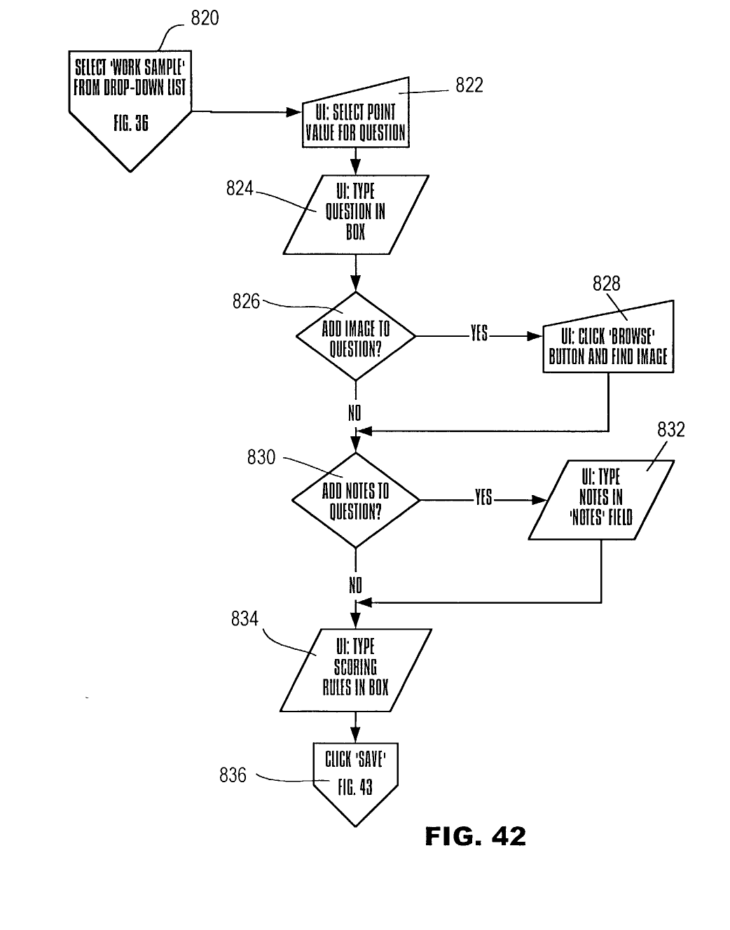

When the user elects to enter a work sample question, link 820 calls the procedure of FIG. 42 where the point value of the question is entered in step 822, the question is entered in a test box in step 824, an image can be added to the question using steps 826 and 828, and a note can be added to the question using steps 830 and 832. The scoring rules are typed in a text box in step 834 and the question is saved in step 836.

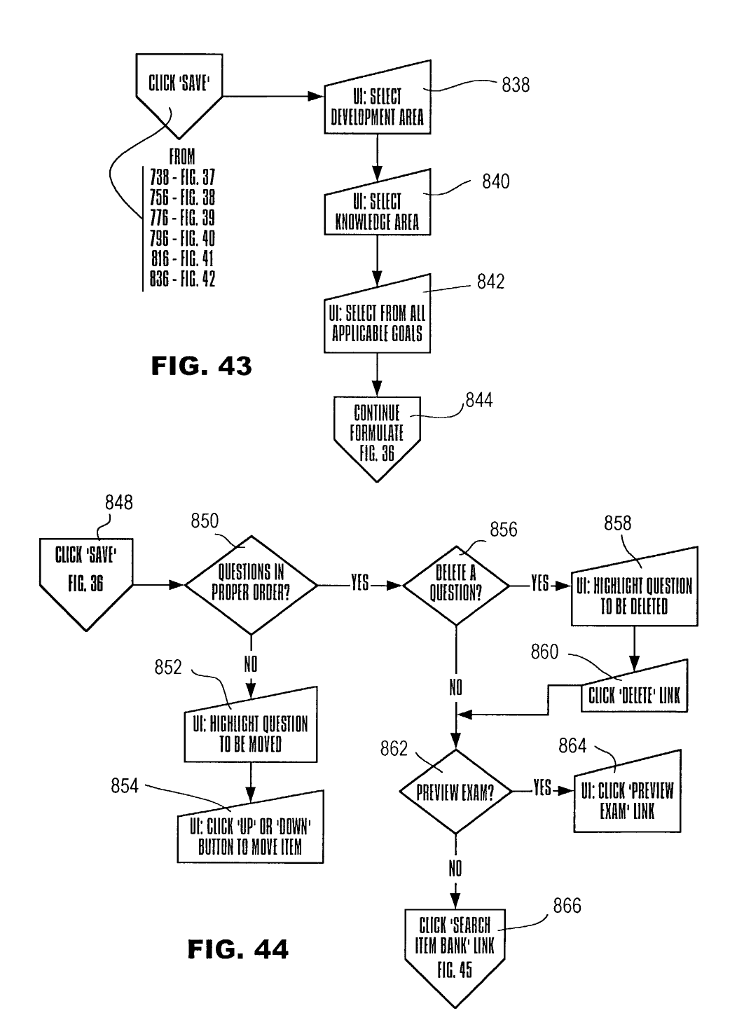

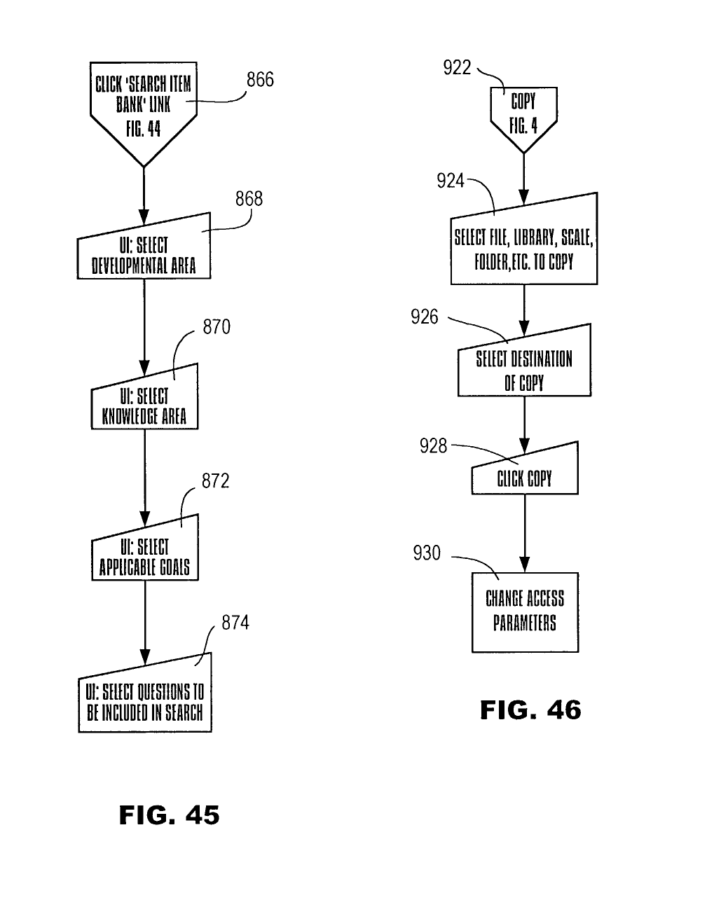

From each of the save steps 738 in FIG. 37, 756 in FIG. 38, 776 in FIG. 39, 796 in FIG. 40, 816 in FIG. 41 and 838 in FIG. 42, the program calls the procedure of FIG. 43. The user selects the development area in step 838, the knowledge area in step 840 and the goals in step 842 to which the question is to be associated. In save step 844 the program returns to the continue formulation step 846 in FIG. 36 to continue the formulate questions routine until the exam is complete or the sum of the points of the entered questions equals the total points of the exam set in step 686. When the exam is completed, link 840 calls the edit questions procedure of FIG. 44 wherein a list of the questions in their order is displayed in step 850. The user in step 852 can highlight a question and in step 854 move the highlighted question to a different position in the list to change the order of the questions on the exam. Steps 856, 858 and 860 can be used to delete a question from the list highlighting and clicking a delete button, the user will also need to add a new question or change the point total of the exam. In steps 862 and 864, the user can elect to preview the exam, i.e., display a real image(s) of the exam as it will appear during a test. Link 866 calls the procedure of FIG. 45 to add information to the search data bank. In steps 868, 870 and 872, the user enters the development area, the knowledge area and the applicable goals of the exam. The questions to be included in the search data bank are selected in step 874.

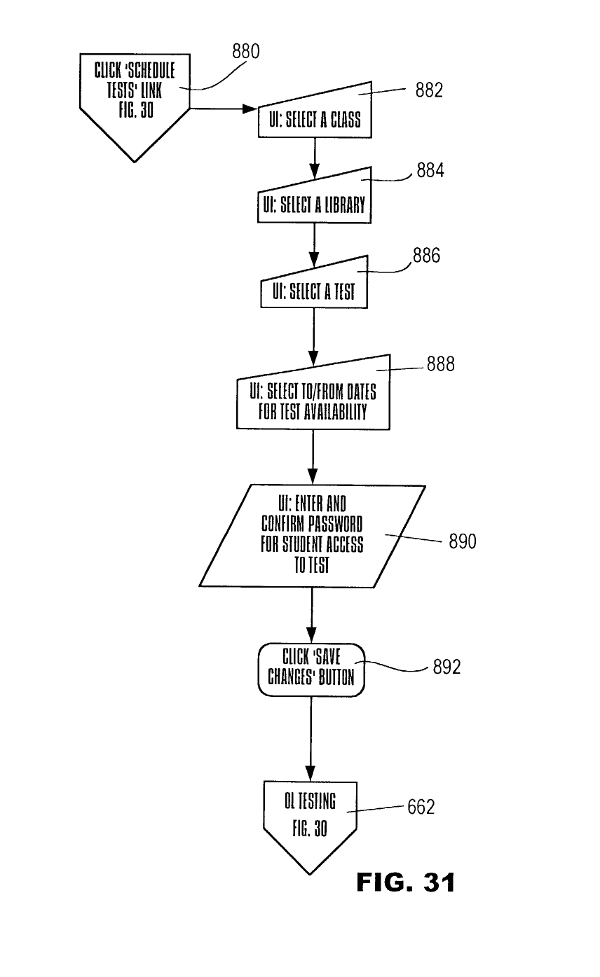

Returning to the on-line services procedure of FIG. 30, a user can select a test schedule link displayed in step 666 which uses link 880 to call the procedure of FIG. 31. Steps 882, 884, 886 and 888 are used by the teacher to select a class, select a library, select a test from the library and to assign dates between which the exam is to be taken by a student. In step 890, a password is entered for student access to the test. The test schedule is saved in step 892 after which the program returns to the procedure of FIG. 30

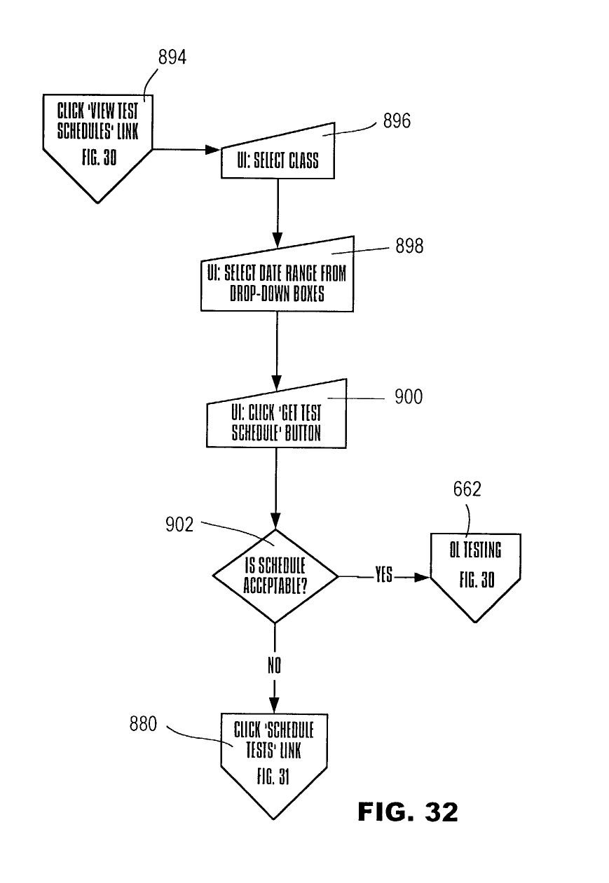

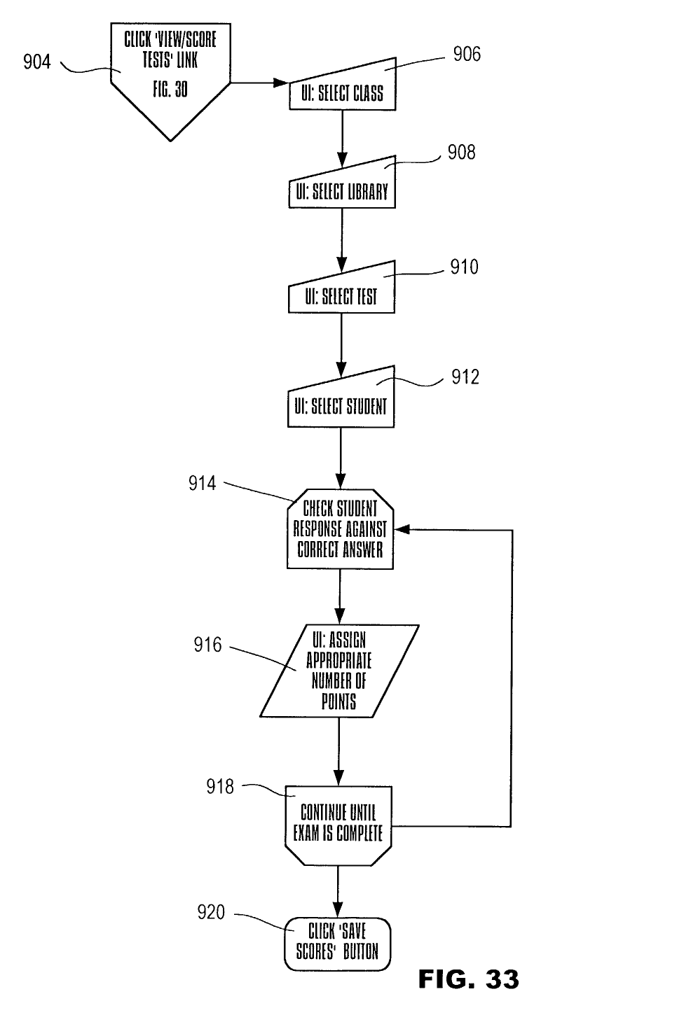

Link 880 in the on line testing service can be clicked to review test schedules by the procedure of FIG. 32. The user selects the class in step 896, selects the date range form a test date list for the selected class in step 898 and calls a test schedule list for the selected date range in step 900. If the schedule is not acceptable, the user clicks on a link 880 to call the schedule test procedure of FIG. 31. If the user clicks OK step 902 returns to the on line test services of FIG. 30.

Child and Family Information services and Staff and Volunteer Information services are similar in that both are used to track information, using both the base-level library component forms and the service component extended forms created with the form builder service. Also, these services can be used to create and delete child/family/staff/volunteer records from the library component. In the Child and Family Information area the user has the opportunity to record specific information about the children and their families within a program. The information here includes attendance and meal counts for the children. In the Staff Information area, the user has the opportunity to record specific and important information about the staff. It is in this area that important forms, such as teacher evaluations, will be kept. The staff information area also facilitates the management of information by providing a place to write and store notes on staff members and keep track of staff attendance. In addition, administrators can use this area to keep a running enrollment account of staff and assign them to classes and duties The volunteer information area is similar to this, as well as administrators being able to use this area to keep a running enrollment account of volunteers and assign them to classes and duties.

Online Help is a separate application that runs much like any standalone software help function. Technical information regarding the online application as well as basic computer information for beginning users is included in the online help.

The flexibility of information available through various service categories is enhanced by the inclusion of the aforementioned form-building service, which enables the user to add fields to existing forms, to create new forms, and to attach the new forms to a particular service. For example, it is possible to attach forms to the child and family information service and thereby customize child and family information. All forms produced using form-builder services are attached to the community component of the system. This controls the deployment of forms created through form-builder. For example, a form built at the agency level is made available to all users in that agency. A special feature of the form-building service is the inclusion of history for all fields produced using form builder. One important use of this feature involves longitudinal studies of student learning. For example, the history feature makes it possible to retrieve a series of scores entered over time in a given data field.

The time component controls when information and services are made available in the system. One function of the time component is to control the period that users are able to access the system. A second function is to control the period that information is active in the system. For example, information on a given class is actively maintained from one year to the next. However, the students in the class may change periodically during the year. A third function of the time component is to maintain history for time-sensitive data. For example, the system enables users to enter data continuously documenting observations of learning. The history component makes it possible to determine developmental accomplishments as of any date within the period in which observations have been recorded.

A copy routine shown in FIG. 46 is called by clicking on a copy link as shown by steps 921 and 922 in FIG. 5 In step 924, the user selects the file, library, scale, folder, etc. to be copied. Files, libraries and scales may be selected from the administrative level, any super agency, any agency, any center or any class to copy. In step 926, the user selects the destination for the material to be copied such as a library or folder within the level of accessability assigned to the user. Clicking on a copy button in step 978 results in copying the selected file to the selected destination. In step 930, parameters of the copied material, such as the title or name and accessability, is changed. The user may then modify the copied to material to meet the user's needs.

Various techniques for limiting write access to files, libraries, scales, score/grade books and other information to ensure that these files, libraries, scales and other information are not changed by unauthorized users of the educational management system. Each of the administrative, super agency, agency, center and class levels may have folders assigned to contain their respective files libraries, scales and other information and write access to folders of higher levels can be prohibited to lower levels. Subfolders within the level folders could further limit write access; for example a score/grade book folder in the class level could limit access to the class creating the score table or grade book Alternatively or additionally, each file, library, scale, score table and grade book can include the level and/or accessability therein as shown in FIG. 2 to limit write access to files, libraries, scales, score tables, grade books.

1. A computerized education management system comprising:
a plurality of files classified into a plurality of different types of files;
means for granting access to the files to a plurality of users classified into corresponding levels of a plurality of hierarchical levels;
said means for granting access providing different rights of access to the different types of the files for the different hierarchical levels, said different rights including read only access, copy access and full access with rights to modify and create records; and
said different file types including a teacher assignment file type, a student class assignment file type, a lesson plan file type and a student achievement file type.

2. A computerized education management system as claimed in claim 1 wherein said means for granting access provides read only and copy access to one user in a first level of the hierarchical levels for files of one of the file types created by a second user in a second level of the hierarchical levels but permits full access with rights to modify copied files of the one file type to create files of the one file type in the first hierarchical level.

3. A computerized education management system as claimed in claim 1 further comprising a form builder including means for entering a title, means for entering subcategories under the title, and means for entering items under each subcategory wherein the items can be selected from a checkbox, a text box and a date field

4. A computerized education management system as claimed in claim 1 wherein the lesson plan files include lesson plans categorized into developmental areas and goals within each developmental area, and the system further includes means of selecting a developmental area to display a listing of goals in the developmental area together with lesson plans assigned to each goal.

5. A computerized educational management system as claimed in claim 1 further comprising
a test builder including means for creating a test by entering a plurality of different types of questions together with answers to the questions wherein each question is selected form a true/false question, a multiple choice question and a text answer question, and means for scoring the test including display of a student's answer for each question together with display of each corresponding answer.
